(19) United States
(12) Patent Application Publication
(10) Pub. No.: US 2024/0026184 A1
(43) Pub. Date: Jan. 25, 2024

(54) FLUOROPOLYETHER GROUP-CONTAINING SILANE COMPOUND

(71) Applicant: Daikin Industries, Ltd., Osaka (JP)

(72) Inventors: Motoshi MATSUI, Osaka (JP); Takashi Nomura, Osaka (JP); Shinya Takano, Osaka (JP); Yukari Honda, Osaka (JP); Yusuke Watanabe, Osaka (JP); Manami Kataoka, Osaka (JP); Akihiro Goto, Osaka (JP)

(73) Assignee: Daikin Industries, Ltd., Osaka (JP)

(21) Appl. No.: 18/374,850

(22) Filed: Sep. 29, 2023

Related U.S. Application Data
(63) Continuation of application No. PCT/JP2022/010368, filed on Mar. 9, 2022.

(30) Foreign Application Priority Data
Mar. 30, 2021 (JP) 2021-058247

(51) Int. Cl. C09D 171/02; C09K 3/18; C09D 5/16; C08G 65/336; C08L 71/02

(52) U.S. Cl. CPC C09D 171/02; C09K 3/18; C09D 5/1637; C08G 65/336; C08L 71/02; G02B 1/18

(57) ABSTRACT

A fluoropolyether group-containing silane compound of the following formula (A1) or (A2). Also disclosed is are surface-treating agent and a pellet including the fluoropolyether group-containing silane compound, and an article including a substrate and a layer on the surface of the substrate formed of fluoropolyether group-containing silane compound. The symbols are as defined in the description.

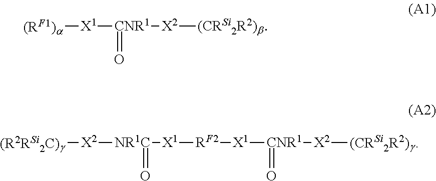

### CROSS REFERENCE TO RELATED APPLICATIONS

This application is a continuation application of International Application No. PCT/JP2022/010368 filed on Mar. 9, 2022 which claims priority from Japanese Patent Application No. 2021-058247 filed on Mar. 30, 2021, the respective disclosures all of which are incorporated herein by reference in their entireties.

The present disclosure relates to a fluoropolyether group-containing silane compound.

### BACKGROUND ART

Certain types of fluorine-containing silane compounds are known to be capable of providing excellent water-repellency, oil-repellency, antifouling property, and the like when used in surface treatment of a substrate. A layer obtained from a surface-treating agent containing a fluorine-containing silane compound (hereinafter, also referred to as a “surface-treating layer”) is applied as a so-called functional thin film to a large variety of substrates such as glass, plastics, fibers, and building materials.

A known such fluorine-containing compound is a fluoropolyether group-containing silane compound having a fluoropolyether group in the molecular backbone and a Si atom boding to hydrolyzable group at the molecular end or the end part (Patent Literature 1).

### PRIOR ART LITERATURE

### Patent Literature

Patent Literature 1: JP 2000-327772 A

### SUMMARY

The present disclosure provides [1] below.
[1]

A fluoropolyether group-containing silane compound of the following formula (A1) or (A2):

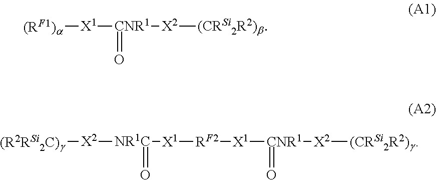

wherein
R^{F1} is represented by R^{f1}—R^{F}—O_{q}—;
R^{F2} is represented by —R^{f2}ₚ—R^{F}—O_{q}—;
Rf¹ is a C₁₋₁₆ alkyl group optionally substituted with one or more fluorine atoms;
Rf² is a C₁₋₆ alkylene group optionally substituted with one or more fluorine atoms;
R^{F} is each independently at each occurrence represented by formula:

—(OC₆F₁₂)ₐ—(OC₅F₁₀)_{b}—(OC₄F₈)_{c}—(OC₃R^{Fa}₆)_{d}—(OC₂F₄)ₑ—(OCF₂)_{f}—;
a, b, c, d, e, and f are each independently an integer of 0 to 200, the sum of a, b, c, d, e, and f is 5 or more, and the occurrence order of the respective repeating units enclosed in parentheses provided with a, b, c, d, e, or f is not limited in the formula;
R^{Fa} is each independently at each occurrence a hydrogen atom, a fluorine atom, or a chlorine atom;
p is 0 or 1;
q is independently 0 or 1;
α is an integer of 1 to 9;
β is an integer of 1 to 9; and
γ is each independently an integer of 1 to 9;
X¹ is each independently at each occurrence a single bond or a di- to decavalent organic group;
R¹ is each independently at each occurrence a hydrogen atom, a C₁₋₄ alkyl group, —R², or —R^{si};
X² is each independently at each occurrence a single bond or a di- to decavalent organic group;
—X¹—C(O)NR¹—X²— is each independently at each occurrence a di- to decavalent organic group;
R² is each independently at each occurrence represented by —CH₂—R⁵¹;
R⁵¹ is each independently a monovalent organic group having an oxyalkylene group;
R^{Si} is each independently at each occurrence represented by the following formula (S1):

—X³—SiR^{b1}ₗ₁R^{c1}₃₋ₗ₁ (S1);
X³ is each independently at each occurrence a single bond, an oxygen atom, or a divalent organic group;
R^{b1} is each independently at each occurrence a hydroxyl group or a hydrolyzable group;
R^{c1} is each independently at each occurrence a hydrogen atom or a monovalent organic group;
l1 is each independently at each occurrence an integer of 0 to 3; and
in each of formulae (A1) and (A2), at least one l1 is 1.

### Advantageous Effect of Invention

According to the present disclosure, it is possible to provide a fluoropolyether group-containing silane compound that can contribute to formation of a surface-treating layer having better physical properties.

### DESCRIPTION OF EMBODIMENTS

The term “monovalent organic group” as used herein represents a carbon-containing monovalent group. The monovalent organic group is not limited, and may be a hydrocarbon group or a derivative thereof. A derivative of a hydrocarbon group means a group having one or more of N, O, S, Si, amide, sulfonyl, siloxane, carbonyl, carbonyloxy, and the like at the terminal or in the molecular chain of the hydrocarbon group.

The “divalent organic group” as used herein is not limited, and examples include a divalent group obtained by removing one more hydrogen atom from the hydrocarbon group.

The term “hydrocarbon group” as used herein represents a group that contains carbon and hydrogen and that is obtained by removing one hydrogen atom from a molecule. The hydrocarbon group is not limited, and examples include a hydrocarbon group that has 1 to 20 carbon atoms and that is optionally substituted with one or more substituents, such as an aliphatic hydrocarbon group and an aromatic hydrocarbon group. The “aliphatic hydrocarbon group” may be either straight, branched, or cyclic, and may be either saturated or unsaturated. The hydrocarbon group may contain one or more ring structures. The hydrocarbon group may have one or more of N, O, S, Si, amide, sulfonyl, siloxane, carbonyl, carbonyloxy, and the like at the terminal or in the molecular chain thereof.

The substituent of the “hydrocarbon group” as used herein is not limited, and examples include one or more groups selected from a halogen atom, and a C₁₋₆ alkyl group, a C₂₋₆ alkenyl group, a C₂₋₆ alkynyl group, a C₃₋₁₀ cycloalkyl group, a C₃₋₁₀ unsaturated cycloalkyl group, a 5 to 10-membered heterocyclyl group, a 5 to 10-membered unsaturated heterocyclyl group, a C₆₋₁₀ aryl group, and a 5 to 10-membered heteroaryl group each optionally substituted with one or more halogen atoms.

Herein, the alkyl group and the phenyl group may be substituted or unsubstituted, unless specified otherwise. A substituent of such a group is not limited, and examples include one or more groups selected from a halogen atom, a C₁₋₆ alkyl group, a C₂₋₆ alkenyl group, and a C₂₋₆ alkynyl group.

The term “hydrolyzable group” as used herein represents a group which is able to undergo a hydrolysis reaction, i.e., represents a group that can be removed from the main backbone of a compound by a hydrolysis reaction. Examples of the hydrolyzable group include —OR^{h}, —OCOR^{h}, —O—N═CR^{h}₂, —NR^{h}₂, —NHR^{h}, —NCO, and halogen (in these formulae, Rh represents a substituted or unsubstituted C₁₋₄ alkyl group), and —OR^{h} (i.e., an alkoxy group) is preferable. Examples of Rh include unsubstituted alkyl groups such as a methyl group, an ethyl group, a propyl group, an isopropyl group, a n-butyl group, and an isobutyl group; and substituted alkyl groups such as a chloromethyl group. Among such groups, an alkyl group or in particular an unsubstituted alkyl group is preferable, and a methyl group or an ethyl group is more preferable. In one embodiment, the hydrolyzable group is a methoxy group. In another embodiment, the hydrolyzable group is an ethoxy group.

The fluoropolyether group-containing silane compound of the present disclosure is a compound represented by the following formula (A1) or (A2).

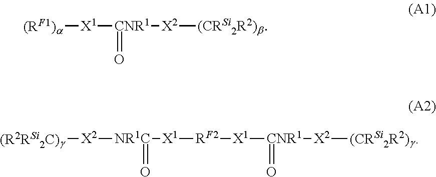

In formula (A1), R^{F1} is represented by Rf¹—R^{F}—O_{q}—.

In formula (A2), R^{F2} is represented by —Rf²ₚ—R^{F}—O_{q}—.
Rf¹ is a C₁₋₁₆ alkyl group optionally substituted with one or more fluorine atoms.

In the C₁₋₁₆ alkyl group optionally substituted with one or more fluorine atoms, the “C₁₋₁₆ alkyl group” may be linear or branched, and is preferably a linear or branched C₁₋₆ alkyl group, in particular C₁₋₃ alkyl group, and more preferably a linear C₁₋₆ alkyl group, in particular a linear C₁₋₃ alkyl group.
Rf¹ is preferably a C₁₋₁₆ alkyl group substituted with one or more fluorine atoms, more preferably a CF₂H—C₁₋₁₅ perfluoroalkylene group, and even more preferably a C₁₋₁₆ perfluoroalkyl group.

The C₁₋₁₆ perfluoroalkyl group may be linear or branched, and is preferably a linear or branched C₁₋₆ perfluoroalkyl group, in particular C₁₋₃ perfluoroalkyl group, more preferably a linear C₁₋₆ perfluoroalkyl group, in particular C₁₋₃ perfluoroalkyl group, and specifically —CF₃, —CF₂CF₃, or —CF₂CF₂CF₃.
Rf² is a C₁₋₆ alkylene group optionally substituted with one or more fluorine atoms.

In the C₁₋₆ alkylene group optionally substituted with one or more fluorine atoms, the “C₁₋₆ alkylene group” may be linear or branched, and is preferably a linear or branched C₁₋₃ alkylene group, and more preferably a linear C₁₋₃ alkylene group.
R^{f2} is preferably a C₁₋₆ alkylene group that is substituted with one or more fluorine atoms, more preferably a C₁₋₆ perfluoroalkylene group, and even more preferably a C₁₋₃ perfluoroalkylene group.

The C₁₋₆ perfluoroalkylene group may be linear or branched, and is preferably a linear or branched C₁₋₃ perfluoroalkylene group, more preferably a linear C₁₋₃ perfluoroalkylene group, and specifically —CF₂—, —CF₂CF₂—, or —CF₂CF₂CF₂—.

In the formula, p is 0 or 1. In one embodiment, p is 0. In another embodiment, p is 1.

In the formulas, q is each independently at each occurrence 0 or 1. In one embodiment, q is 0. In another embodiment, q is 1.

In the formulae (A1) and (A2), R^{F} is each independently at each occurrence a fluoropolyether group represented by the following formula. As for the structure referred to as R^{F}, the left side is bonded to a structure represented by R^{f1} in formula (A1), and the left side is bonded to a structure represented by Rf²ₚ in formula (A2).

—(OC₆F₁₂)ₐ—(OC₅F₁₀)_{b}—(OC₄F₈)_{c}—(OC₃R^{Fa}₆)_{d}—(OC₂F₄)ₑ—(OCF₂)_{f}—

wherein
R^{Fa} is each independently at each occurrence a hydrogen atom, a fluorine atom, or a chlorine atom;
a, b, c, d, e, and f are each independently an integer of 0 to 200; the sum of a, b, c, d, e, and f is 1 or more; and the occurrence order of each repeating unit enclosed in parentheses provided with a, b, c, d, e, or f is not limited in the formula.
R^{Fa} is preferably a hydrogen atom or a fluorine atom, and more preferably a fluorine atom.
a, b, c, d, e and f may preferably each independently be an integer of 0 to 100.

The sum of a, b, c, d, e and f is preferably 5 or more, and more preferably 10 or more, for example, 15 or more, or 20 or more. The sum of a, b, c, d, e and f is preferably 200 or less, and more preferably 100 or less, and even more preferably 60 or less, for example, 50 or less, or 30 or less.

These repeating units may be linear or branched, and are preferably linear. For example, —(OC₆F₁₂)— may be —(OCF₂CF₂CF₂CF₂CF₂CF₂)—, —(OCF(CF₃)CF₂CF₂CF₂CF₂)—, —(OCF₂CF(CF₃)CF₂CF₂CF₂)—, —(OCF₂CF₂CF(CF₃)CF₂CF₂)—, —(OCF₂CF₂CF₂CF(CF₃)CF₂)—, —(OCF₂CF₂CF₂CF₂CF(CF₃))—, or the like, and is preferably —(OCF₂CF₂CF₂CF₂CF₂CF₂)—. —(OC₅F₁₀)— may be —(OCF₂CF₂CF₂CF₂CF₂)—, —(OCF(CF₃)CF₂CF₂CF₂)—, —(OCF₂CF(CF₃)CF₂CF₂)—, —(OCF₂CF₂CF(CF₃)CF₂)—, —(OCF₂CF₂CF₂CF(CF₃))—, or the like, and is preferably —(OCF₂CF₂CF₂CF₂CF₂)—. —(OC₄F₈)— may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C₂F₅)CF₂)—, and —(OCF₂CF(C₂F₅))—, and is preferably —(OCF₂CF₂CF₂CF₂)—. —(OC₃F₆)— (that is to say, in the formula, R^{Fa} is a fluorine atom) may be any of —(OCF₂CF₂CF₂)—, —(OCF(CF₃)CF₂)—, and —(OCF₂CF(CF₃))—, and is preferably —(OCF₂CF₂CF₂)—. Also, —(OC₂F₄)— may be any of —(OCF₂CF₂)— and —(OCF(CF₃))—, and is preferably —(OCF₂CF₂)—.

In one embodiment, RF is each independently at each occurrence represented by the following formula (f1), (f2), (f3), (f4), or (f5):

—(OC₃F₆)_{d}—(OC₂F₄)ₑ— (f1)
wherein d is an integer of 1 to 200; and e is 0 or 1, preferably 1.

—(OC₄F₈)_{c}—(OC₃F₆)_{d}—(OC₂F₄)ₑ—(OCF₂)_{f}— (f2)
wherein c and d are each independently an integer of 0 or more and 30 or less, e and f are each independently an integer of 1 or more and 200 or less,
   the sum of c, d, e, and f is 2 or more, and
   the occurrence order of each repeating unit enclosed in parentheses provided with a subscript c, d, e, or f is not limited in the formula;

—(R⁶—R⁷)_{g}— (f3)
wherein R⁶ is OCF₂ or OC₂F₄,
   R⁷ is a group selected from OC₂F₄, OC₃F₆, OC₄F₈, OC₅F₁₀, and OC₆F₁₂, or is a combination of two or three groups independently selected from these groups, and
g is an integer of 2 to 100;

—(OC₆F₁₂)ₐ—(OC₅F₁₀)_{b}—(OC₄F₈)_{c}—(OC₃F₆)_{d}—(OC₂F₄)ₑ—(OCF₂)_{f}— (f4)
wherein e is an integer of 1 or more and 200 or less, a, b, c, d, and f are each independently an integer of 0 or more and 200 or less, the sum of a, b, c, d, e, and f is at least 1, and the occurrence order of each repeating unit enclosed in parentheses provided with a, b, c, d, e, or f is not limited in the formula; and

—(OC₆F₁₂)ₐ—(OC₅F₁₀)_{b}—(OC₄F₈)_{c}—(OC₃F₆)_{d}—(OC₂F₄)ₑ—(OCF₂)_{f}— (f5)
wherein f is an integer of 1 or more and 200 or less, a, b, c, d, and e are each independently an integer of 0 or more and 200 or less, the sum of a, b, c, d, e, and f is at least 1, and the occurrence order of each repeating unit enclosed in parentheses provided with a, b, c, d, e, or f is not limited in the formula.

In the formula (f1), d is preferably an integer of 5 to 200, more preferably 10 to 100, even more preferably 15 to 50, for example 25 to 35. In the formula (f1), (OC₃F₆) is preferably a group represented by (OCF₂CF₂CF₂) or (OCF(CF₃)CF₂), and more preferably a group represented by (OCF₂CF₂CF₂). In the formula (f1), (OC₂F₄) is preferably a group represented by (OCF₂CF₂) or (OCF(CF₃)), and more preferably a group represented by (OCF₂CF₂).

In the formula (f2), e and f are each independently, preferably an integer of 5 or more and 200 or less, and more preferably 10 to 200. The sum of c, d, e, and f is preferably 5 or more and more preferably 10 or more, and may be, for example, 15 or more or 20 or more. In one embodiment, formula (f2) is preferably a group represented by —(OCF₂CF₂CF₂CF₂)_{c}—(OCF₂CF₂CF₂)_{d}—(OCF₂CF₂)ₑ—(OCF₂)_{f}—. In another embodiment, the formula (f2) may be a group represented by —(OC₂F₄)ₑ—(OCF₂)_{f}—.

In the formula (f3), R⁶ is preferably OC₂F₄. In formula (f3), R⁷ is preferably a group selected from OC₂F₄, and OC₄F₈, or a combination of two or three groups independently selected from these groups, and is more preferably a group selected from OC₃F₆ and OC₄F₈. Examples of the combination of 2 or 3 groups independently selected from OC₂F₄, OC₃F₆, and OC₄F₈ include, but are not limited to, —OC₂F₄OC₃F₆—, —OC₂F₄OC₄F₈—, —OC₃F₄OC₂F₄—, —OC₃F₆OC₃F₆—, —OC₃F₆OC₄F₈—, —OC₄F₈OC₄F₈—, —OC₄F₈OC₃F₆—, —OC₄F₈OC₂F₄—, —OC₂F₄OC₂F₄OC₃F₆—, —OC₂F₄OC₂F₄OC₄F₈—, —OC₂F₄OC₃F₆OC₂F₄—, —OC₂F₄OC₃F₆OC₃F₆—, —OC₂F₄OC₄F₈OC₂F₄—, —OC₃F₆OC₂F₄OC₂F₄—, —OC₃F₆OC₂F₄OC₃F₆—, —OC₃F₆OC₃F₆OC₂F₄—, and —OC₄F₈OC₂F₄OC₂F₄—. In formula (f3), g is preferably an integer of 3 or more, and more preferably 5 or more. g is preferably an integer of 50 or less. In formula (f3), OC₂F₄, OC₃F₆, OC₄F₈, OC₅F₁₀, and OC₆F₁₂ may be either straight or branched, and are preferably straight. In this embodiment, the formula (f3) is preferably —(OC₂F₄—OC₃F₆)_{g}— or —(OC₂F₄—OC₄F₈)_{g}—.

In the formula (f4), e is preferably an integer of 1 or more and 100 or less, and more preferably 5 or more and 100 or less. The sum of a, b, c, d, e and f is preferably 5 or more, and more preferably 10 or more, such as 10 or more and 100 or less.

In the formula (f5), f is preferably an integer of 1 or more and 100 or less, and more preferably 5 or more and 100 or less. The sum of a, b, c, d, e and f is preferably 5 or more, and more preferably 10 or more, such as 10 or more and 100 or less.

In one embodiment, R^{F} is a group represented by the formula (f1).

In one embodiment, R^{F} is a group represented by the formula (f2).

In one embodiment, R^{F} is a group represented by the formula (f3).

In one embodiment, R^{F} is a group represented by the formula (f4).

In one embodiment, R^{F} is a group represented by the formula (f5).

In a preferable embodiment, R^{F} is a group represented by formula (f2):

—(OC₄F₈)_{c}—(OC₃F₆)_{d}—(OC₂F₄)ₑ—(OCF₂)_{f}—.

In the formula, c and d are each independently an integer of 0 or more and 30 or less, e and f are each independently an integer of 1 or more and 200 or less, preferably 5 or more and 200 or less, and more preferably 10 or more and 200 or less, and the occurrence order of the respective repeating units enclosed in parentheses provided with a subscript e or f is not limited in the formula. More specifically, R^{F} may be a group represented by —(OC₂F₄)ₑ—(OCF₂)_{f}—.

The ratio of e to f in R^{F} (hereinafter, referred to as an “e/f ratio”) is 0.1 to 10, preferably 0.2 to 5, more preferably 0.2 to 2, even more preferably 0.2 to 1.5, and further preferably 0.2 to 0.85. With an e/f ratio of 10 or less, the lubricity, friction durability, and chemical resistance (such as durability against artificial sweat) of a cured layer (such as a surface-treating layer) obtained from the compound containing R^{F} are further increased. The smaller the e/f ratio is, the higher the lubricity and the friction durability of the surface-treating layer are. On the other hand, with an e/f ratio of 0.1 or more, the stability of the compound can be further increased. The larger the e/f ratio is, the higher the stability of the compound is. In this case, the value of f is 1 or more.

In one embodiment, the e/f ratio is preferably 0.2 to 0.95, and more preferably 0.2 to 0.9.

In one embodiment, the e/f ratio is preferably 0.20 or more and less than 1.0, more preferably 0.20 to 0.95, more preferably 0.20 to 0.90, even more preferably 0.40 to 0.80, and particularly preferably 0.50 to 0.70.

In one embodiment, the e/f ratio is preferably 0.20 to 0.80, and more preferably 0.30 to 0.70. In another embodiment, the e/f ratio is 0.50 to 0.80.

In one embodiment, from the viewpoint of heat resistance, the e/f ratio is preferably 1.0 or more, and more preferably 1.0 to 2.0.

In one embodiment, the e/f ratio is 0.2 to 1.5, and preferably 0.5 to 1.1.

In R^{F}, the e/f ratio may be less than 1.0, may be or less, may be 0.90 or less, may be less than 0.90, and may be, for example, 0.8 or less, or 0.70 or less. The e/f ratio is preferably 0.20 or more, more preferably or more, even more preferably 0.40 or more, and particularly preferably 0.50 or more. The e/f ratio is, for example, 0.20 or more and less than 1.0, and examples thereof may include 0.20 or more and 0.95 or less, 0.20 or more and less than 0.90, specifically 0.40 or more and 0.80 or less, and more specifically 0.50 or more and 0.70 or less. If the e/f ratio is excessively low, there is a possibility that the hydrolyzability of a cured layer formed using the fluoropolyether group-containing silane compound of the present disclosure (or a cured film, the same applies hereinafter) increases, so that the durability of the cured layer is deteriorated. If the e/f ratio is excessively high, there is a possibility that the dynamic friction coefficient of a cured layer formed using the fluoropolyether group-containing silane compound of the present disclosure increases, and it is not possible to obtain a cured layer having sufficient friction durability.

In a preferable embodiment, R^{F} is a group represented by:

—(OC₄F₈)_{c}—(OC₃F₆)_{d}—(OC₂F₄)ₑ—(OCF₂)_{f}— (f2)
wherein c and d are each independently an integer of 0 or more and 30 or less, e and f are each independently an integer of 1 or more and 200 or less, preferably 5 or more and 200 or less, and more preferably 10 or more and 200 or less, and the occurrence order of the respective repeating units enclosed in parentheses provided with a subscript e or f is not limited in the formula, and the e/f ratio is 0.20 or more and less than 1.0, more preferably 0.20 to 0.95, more preferably 0.20 to 0.90, even more preferably 0.40 to 0.80, and particularly preferably 0.50 to 0.70. More specifically, R^{F} may be a group represented by —(OC₂F₄)ₑ—(OCF₂)_{f}—.

By using a compound having R^{F} as described above, the chemical durability (chemical resistance), friction durability, water-repellency, oil-repellency, antifouling property (for example, preventing grime such as fingerprints from adhering), waterproof property (preventing water from penetrating into an electronic component and the like), surface lubricity (or a lubricating property, for example, wiping property of grime such as fingerprints, and excellent texture to fingers) of a cured layer formed using the compound are improved. This may be because use of a compound having R^{F} as described above causes a decrease in dynamic friction coefficient of a surface of a cured layer formed from the compound.

In one embodiment, R^{F} is a group represented by:

—(OC₄F₈)_{c}—(OC₃F₆)_{d}—(OC₂F₄)ₑ—(OCF₂)_{f}— (f2)
wherein c and d are each independently an integer of 0 or more and 30 or less, e and f are each independently an integer of 1 or more and 200 or less, preferably 5 or more and 200 or less, and more preferably 10 or more and 200 or less, and the occurrence order of the respective repeating units enclosed in parentheses provided with a subscript e or f is not limited in the formula.

The e/f ratio is 0.20 to 0.80, and more preferably to 0.70.

In one embodiment, e and f may be an integer of 10 or more and 100 or less and an integer of l1 or more and 100 or less, respectively, and e and f may be an integer of 15 or more and 70 or less and an integer of 21 or more and 95 or less, respectively.

In one embodiment, the sum of e and f is preferably 20 or more, more preferably 30 or more, and particularly preferably 40 or more.

In another embodiment, the sum of e and f is preferably 100 or more, more preferably 120 or more, even more preferably 130 or more, and particularly preferably 140 or more.

In one embodiment, the sum of e and f is preferably 200 or less, more preferably 180 or less, even more preferably 160 or less, and particularly preferably 150 or less.

The number average molecular weight of R^{F1} and R^{F2} moieties is not limited, and is, for example, 500 to 30,000, preferably 1,500 to 30,000, more preferably 2,500 to 30,000, and even more preferably 4,000 to 30,000. The number average molecular weight of R^{F1} and R^{F2} moieties may be, for example, 2,500 to 20,000, 2,500 to 15,000, 3,000 to 15,000, or 2,000 to 10,000. Herein, the number average molecular weights of R^{F1} and R^{F2} are values measured by ¹⁹F-NMR.

In another embodiment, the number average molecular weights of the R^{F1} and R^{F2} moieties may be 500 to 30,000, preferably 1,000 to 20,000, more preferably 2,000 to 15,000, and further preferably 2,000 to 10,000, such as 3,000 to 6,000.

In another embodiment, the number average molecular weights of the R^{F1} and R^{F2} moieties may be 6,000 to 30,000, preferably 6,000 to 20,000, more preferably 7,000 to 20,000, still more preferably 8,000 to 1,5000, particularly preferably 9,000 to 15,000, and further more preferably 10,000 to 15,000. The number average molecular weight of R^{F1} and R^{F2} moieties may be, for example, in the range of 6,000 to 15,000.

In one embodiment, in the fluoropolyether group-containing silane compound of the present disclosure,
the number average molecular weights of R^{F1} and R^{F2} moieties are in the range of 6,000 to 20,000, and the e/f ratio is in the range of 0.50 to 0.80;
preferably, the number average molecular weights of R^{F1} and R^{F2} moieties are in the range of 6,000 to 15,000, and the e/f ratio is in the range of 0.50 to 0.70; and
more preferably, the number average molecular weights of R^{F1} and R^{F2} moieties are in the range of 10,000 to 15,000, and the e/f ratio is in the range of 0.50 to

In the present embodiment, R^{F} is preferably a group represented by —(OC₄F₈)_{c}—(OC₃F₆)_{d}—(OC₂F₄)ₑ—(OCF₂)_{f}—. Here, for example, c and d are each independently an integer of 0 or more and 30 or less, e is an integer in the range of 20 to 70, and f is an integer in the range of 45 to 120. Such a fluoropolyether group-containing silane compound can contribute to formation of a cured layer (e.g., surface-treating layer) having an extremely high lubricating property and having lubricity based on a low dynamic friction coefficient.

The group represented by R^{F1} or R^{F2} and the group represented by R^{Si}₂R² are bonded via the group represented by —X¹C(O)NR¹—X²—. The group represented by R^{F1} or R^{F2} is a group containing a fluoropolyether group that mainly provides water-repellency, surface lubricity, and the like, and the group represented by CR^{Si}₂R² is a silane moiety that provides the ability to bind to a substrate. Since the fluoropolyether group-containing silane compound represented by formula (A1) and/or the fluoropolyether group-containing silane compound represented by formula (A2) contains C(O)—N, the chemical resistance (e.g., resistance to a strong alkali aqueous solution and a strong acid aqueous solution, and resistance to oxidation by active oxygen species) of a cured layer can be improved.

In a group represented by —X¹—C(O)NR¹—X²—, X¹ is each independently at each occurrence a single bond or a di- to decavalent organic group, and X² is each independently at each occurrence a single bond or a di- to decavalent organic group. The group represented by —X¹—C(O)NR¹—X²— is each independently at each occurrence a di- to decavalent organic group.

In formula (A1), α is an integer of 1 to 9, and β is an integer of 1 to 9. In formula (A2), γ is each independently an integer of 1 to 9.

In one embodiment, —X¹—C(O)NR¹—X²— is a divalent organic group, α is 1, and β is 1.

In one embodiment, —X¹—C(O)NR¹—X²— is a divalent organic group, and γ is 1.

In one embodiment, —X¹—C(O)NR¹—X²— is a tri- to hexavalent organic group, α is 1, and β is 2 to 5.

In one embodiment, —X¹—C(O)NR¹—X²— is a tri- to hexavalent organic group, and γ is 2 to 5.

In one embodiment, —X¹—C(O)NR¹—X²— is a trivalent organic group, α is 1, and β is 2.

In one embodiment, —X¹—C(O)NR¹—X²— is a trivalent organic group, and γ is 2.

In one embodiment, α is 1, and X¹ is a single bond, or a divalent organic group.

In one embodiment, X¹ is a single bond.

In one embodiment, X¹ is a divalent organic group.

In one embodiment, X¹ is each independently at each occurrence a single bond, or a divalent organic group represented by the following formula:

—(R⁸⁰)ₚ₄—. Herein, the left side of the structure of X¹ binds to R^{F1} or R^{F2}, and the right side of X¹ binds to C(O)N.

In the formula:
R⁸⁰ each independently at each occurrence represents a C₁₋₄ alkylene group optionally substituted with one or more fluorine atoms, or a phenylene group, and
p4 is 1 or 2. As used herein, the term “phenylene group” refers to an o-, m- or p-phenylene group unless otherwise specified.

In one embodiment, examples of X′ include a single bond or a divalent organic group represented by the following formula:

—(R⁸¹)ₚ₅—(X⁸¹)_{q5}—.

In the formula:
R⁸¹ is each independently a single bond, —(CH₂)ₛ₅— or an o-, m- or p-phenylene group, and preferably —(CH₂)ₛ₅—,
s5 is an integer of 1 to 20, preferably 1 to 6, more preferably 1 to 3, and still more preferably 1 or 2,
X⁸¹ represents —(X⁸²)₁₅—,
X⁸² is each independently a group selected from the group consisting of —O—, —S—, an o-, m- or p-phenylene group, —C(O)O—, —Si(R⁸³)₂—, —(Si(R⁸³)₂O)ₘ₅—Si(R⁸³)₂—, —NR⁸⁴— and —(CH₂)ₙ₅—,
R⁸³ is each independently at each occurrence a phenyl group, a C₁₋₆ alkyl group or a C₁₋₆ alkoxy group, preferably a phenyl group or a C₁₋₆ alkyl group, and more preferably a methyl group,
R⁸⁴ is each independently at each occurrence a hydrogen atom, a phenyl group or a C₁₋₆ alkyl group (preferably a methyl group),
m5 is each independently at each occurrence an integer of 1 to 100 and preferably an integer of 1 to 20,
n5 is each independently at each occurrence an integer of 1 to 20, preferably an integer of 1 to 6, and more preferably an integer of 1 to 3,
15 is an integer of 1 to 10, preferably an integer of 1 to 5, and more preferably an integer of 1 to 3,
p5 is 0 or 1,
q5 is 0 or 1, and
at least one of p5 and q5 is 1, and the occurrence order of the respective repeating units enclosed in parentheses provided with p5 or q5 is not limited.

In one embodiment, p5 is 1, q5 is 0. In another embodiment, p5 is 1, q5 is 1. In still another embodiment, p5 is 0, q5 is 1.
X¹ (typically, hydrogen atoms of X¹) is optionally substituted with one or more substituents selected from a fluorine atom, a C₁₋₃ alkyl group, and a C₁₋₃ fluoroalkyl group. In a preferable embodiment, X¹ is not substituted with these groups.

In one embodiment, X¹ is each independently
—(R⁸¹)ₚ₅—(X⁸¹)_{q5}—R⁸²—. R⁸² represents a single bond, —(CH₂)ₜ₅—, an o-, m-, or a p-phenylene group, and is preferably —(CH₂)ₜ₅—. t5 is an integer of 1 to 20, preferably an integer of 2 to 6, and more preferably an integer of 2 to 3. X¹ (typically, hydrogen atoms of X¹) is optionally substituted with one or more substituents selected from a fluorine atom, a C₁₋₃ alkyl group, and a C₁₋₃ fluoroalkyl group. In a preferable embodiment, X¹ is not substituted with these groups.

In one embodiment, X¹ is an o-, m- or p-phenylene group.

In one embodiment, X¹ is a C₁₋₄ alkyl group optionally substituted with one or more fluorine atoms.

In one embodiment, X¹ is a C₁₋₄ alkyl group having no substituent (i.e., a group represented by —CH₂—, —C₂H₄—, —C₃H₆—, or —C₄H₈—).

In one embodiment, β is 1, and X² is a single bond, or a divalent organic group.

In one embodiment, γ is 1, and X² is a single bond, or a divalent organic group.

In one embodiment, X² is a single bond.

In one embodiment, X² is a divalent organic group.

In one embodiment, X² is each independently at each occurrence a single bond, or a divalent organic group represented by the following formula:
—(R^{80′})ₚ₄′—. Herein, the left side of the structure of X² binds to C(O)N, and the right side of X² binds to (CR^{Si}₂R²)_{γ}.

In the formula:
R^{80′} each independently at each occurrence represents a C₁₋₄ alkylene group optionally substituted with one or more fluorine atoms, or a phenylene group, and
p4′ is 1 or 2.

In one embodiment, X² is a divalent organic group represented by —CH₂—(RX^{80″″})_{p4″″}—. R^{80″″} represents a C₁₋₄ alkylene group (e.g., C₁₋₃ alkylene group) optionally substituted with one or more fluorine atoms, or a phenylene group, and
p4″″ is 1 or 2.

In one embodiment, X² is a divalent organic group represented by —CH₂—(RX^{80″″})_{p4″″}—, and p4″″ is 0. R^{80″″} has the same definition as above.

In one embodiment, examples of X² include a single bond or a divalent organic group represented by the following formula:

—(R^{81′})_{p5′}—(X^{81′})_{q5′}—.

In the formula, R^{81′}, p5′, X^{81′} and q5′ have the same definition as R⁸¹, p5, X⁸¹ and q5 of X¹.

In one embodiment, X² is each independently
—(R^{81′})_{p5′}—(X^{81′})_{q5′}—R^{82′}—. In the formula, R^{81′}, p5′, X^{81′}, q5′ and R^{82′} have the same definition as R⁸¹, p5, X⁸¹, q5 and R⁸², respectively, of X¹.

In one embodiment, X² is an o-, m- or p-phenylene group.

In one embodiment, X² is a C₁₋₄ alkylene group optionally substituted with one or more fluorine atoms.

In one embodiment, X² is a C₁₋₄ alkylene group having no substituent.

In one embodiment, X¹ is a single bond, or a C₁₋₄ alkylene group optionally substituted with one or more fluorine atoms, and X² is a single bond, or a C₁₋₄ alkylene group optionally substituted with one or more fluorine atoms.

In one embodiment, in —X¹C(O)NR¹—X²—, X¹ is a single bond and X² is a C₁₋₄ alkylene group optionally substituted with one or more fluorine atoms; preferably, X¹ is a single bond and X² is a group represented by —CₙH₂ₙ— (n is an integer of 1 to 4); and for example, X¹ is a single bond and X² is —CH₂—. Due to such a structure, in particular, the effect of the amide group may be more significantly exhibited.

In formulae (A1) and (A2), R¹ is each independently at each occurrence a hydrogen atom, a C₁₋₄ alkyl group, a group represented by —R², or a group represented by —R^{Si}.

In one embodiment, R¹ is a hydrogen atom.

In one embodiment, R¹ is a C₁₋₄ alkyl group, and preferably —CH₃.

In one embodiment, R¹ is a group represented by —R².

In one embodiment, R¹ is a group represented by —R^{Si}.

R^{Si} is each independently at each occurrence represented by the following formula (S1):

—X³—SiR^{b1}ₗ₁R^{c1}₃₋ₗ₁ (S1)

In formula (S1), X³ is each independently at each occurrence a single bond, an oxygen atom, or a divalent organic group.

In a preferred embodiment, X³ is a divalent organic group.

X³ is preferably a C₁₋₆ alkylene group, —(CH₂)_{z11}—O—(CH₂)_{z12}—, or —(CH₂)_{z13}-phenylene-(CH₂)_{z14}—. The C₁₋₆ alkylene group may be straight or branched, and is preferably straight. These groups may be substituted with one or more substituents selected from, for example, a fluorine atom, a C₁₋₆ alkyl group, a C₂₋₆ alkenyl group, and a C₂₋₆ alkynyl group, and are preferably unsubstituted.

In the formula, z11 is an integer of 0 to 6, for example, an integer of 1 to 6, and z12 is an integer of 0 to 6, for example, an integer of 1 to 6. Preferably, the sum of z11 and z12 is 1 or more.

In the formula, z13 is an integer of 0 to 6, for example, an integer of 1 to 6, and z14 is an integer of 0 to 6, for example, an integer of 1 to 6. Preferably, the sum of z13 and z14 is 1 or more.

X³ is more preferably a C₁₋₆ alkylene group, and may be, for example, —CH₂CH₂CH₂—. In another embodiment, X³ may be —CH₂CH₂—.

R^{b1} is each independently at each occurrence a hydroxyl group or a hydrolyzable group.

Preferably, R^{b1} is each independently at each occurrence —OR^{h}, —OCOR^{h}, —O—N═CR^{h}₂, —NR^{h}₂, —NHR^{h}, —NCO, or halogen (in these formulae, R^{h} represents a substituted or unsubstituted C₁₋₄ alkyl group), and more preferably —OR^{h} (i.e., an alkoxy group). Examples of R^{h} include unsubstituted alkyl groups such as a methyl group, an ethyl group, a propyl group, an isopropyl group, a n-butyl group, and an isobutyl group; and substituted alkyl groups such as a chloromethyl group. Among such groups, an alkyl group or in particular an unsubstituted alkyl group is preferable, and a methyl group or an ethyl group is more preferable. In one embodiment, R^{h} is a methyl group, and in another embodiment, R^{h} is an ethyl group.

R^{c1} is each independently at each occurrence a hydrogen atom or a monovalent organic group. Such a monovalent organic group excludes hydrolyzable group.

In R^{c1}, the monovalent organic group is preferably a C₁₋₂₀ alkyl group, more preferably a C₁₋₆ alkyl group, and even preferably a methyl group.

Here, l1 is each independently at each occurrence an integer of 0 to 3. In each of formulae (A1) and (A2), at least one l1 is 1. In other words, in each of formulae (A1) and (A2), at least one R^{b1} is present in R^{Si}.

Preferably, l1 is each independently at each occurrence an integer of 1 to 3, and l1 is more preferably 2 or 3, and even more preferably 3.

Preferably, at least one R^{b1} is present for each group represented by formula (S1). In other words, when R^{Si} is represented by formula (S1), the R^{Si} moiety at the end of each of formulae (A1) and (A2) (hereinafter, also referred to simply as an “end part” of each of formulae (A1) and (A2)) has a Si atom to which a hydroxyl group or a hydrolyzable group is bonded.

Preferably, at least two Si atom to which a hydroxyl group or a hydrolyzable group is bonded are present at the end part of formula (A1) and formula (A2).

In formulae (A1) and (A2), R² is each independently at each occurrence represented by —CH₂—R⁵¹.
R⁵¹ is each independently a monovalent organic group having an oxyalkylene group. Here, the oxyalkylene group is a group consisting of one or more oxygen atoms and two or more carbon atoms, and may be a linear structure, or may form a ring structure.

Preferably, —R⁵¹ is each independently at each occurrence represented by —R⁵²—O—(R⁵³—O)ₙ₄—R⁵⁴ or —R⁵⁵—R⁵⁶.

In one embodiment, R⁵¹ is each independently at each occurrence represented by —R⁵²—O—(R⁵³—O)ₙ₄—R⁵⁴.
R⁵² is each independently a single bond or a C₁₋₁₀ alkylene group.

In one embodiment, R⁵² is a single bond.

In one embodiment, R⁵² is a C₁₋₁₀ alkylene group, and preferably a C₁₋₄ alkylene group.

n4 is each independently an integer of 0 to 10.

In one embodiment, n4 is 0.

In one embodiment, n4 is an integer of 1 to 10, and preferably an integer of 1 to 6.
R⁵³ is each independently a C₁₋₄ alkylene group, and preferably a C₁₋₂ alkylene group, such as —CH₂CH—₂ or —CH₂—.
R⁵⁴ is each independently a monovalent hydrocarbon group optionally containing a ring structure.

Examples of the monovalent hydrocarbon group containing a ring structure may include monovalent hydrocarbon groups containing a group having an aromatic ring, a cycloalkyl group, or a heterocycloalkyl group.

Examples of the group having an aromatic ring may include a phenyl group.

Examples of the cycloalkyl group may include C₃₋₁₀ cycloalkyl groups, specifically a cyclopentyl group, a cyclohexyl group and a cycloheptyl group.

Examples of the heterocycloalkyl group may include cycloalkyl groups containing an oxygen atom.

Examples of the monovalent hydrocarbon group containing a ring structure may include the following structures. The right side of —(R⁵³—O)ₙ₄— binds to the part provided with * in the following structures.

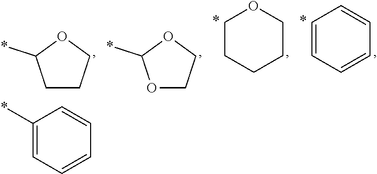

R⁵⁴ is preferably a C₁₋₄ alkyl group, and more preferably a C₁₋₂ alkyl group.

In one embodiment, R⁵¹ is each independently at each occurrence represented by —R⁵²—O—(R⁵³—O)ₙ₄—R⁵⁴,
R⁵² is each independently a single bond or a C₁₋₄ alkylene group,
R⁵³ is each independently a C₁₋₄ alkylene group,
n4 is each independently an integer of 0 to 10, and
R⁵⁴ is each independently a monovalent hydrocarbon group optionally containing a ring structure. Preferably, R⁵⁴ is each independently a C₁₋₄ alkyl group.

In one embodiment, R⁵¹ is each independently at each occurrence represented by —R⁵²—O—(R⁵³—O)ₙ₄—R⁵⁴,
R⁵² is a single bond or a C₁₋₄ alkylene group,
R⁵³ is each independently a C₁₋₄ alkylene group,
n4 is each independently an integer of 1 to 10, and
R⁵⁴ is each independently a monovalent hydrocarbon group optionally containing a ring structure. Preferably, R⁵⁴ is each independently a C₁₋₄ alkyl group.

In one embodiment, R⁵¹ is each independently at each occurrence represented by —R⁵²—O—(R⁵³—O)ₙ₄—R⁵⁴,
R⁵² is a single bond, or C₁₋₄ alkylene group, and preferably a C₁₋₄ alkylene group,
R⁵³ is each independently a C₁₋₄ alkylene group,
n4 is 0,
R⁵⁴ is each independently a monovalent hydrocarbon group optionally containing a ring structure, and preferably a C₁₋₄ alkyl group. That is, in the present embodiment, R⁵¹ is represented by —R⁵²—O—R⁵⁴.

In one embodiment, R⁵¹ is each independently at each occurrence represented by —R⁵⁵—R⁵⁶.
R⁵⁵ is each independently a single bond or a C₁₋₄ alkylene group.

In one embodiment, R⁵⁵ is a single bond.

In one embodiment, R⁵⁵ is each independently a C₁₋₄ alkylene group (e.g., a group represented by —CH₂—, —C₂H₄—, —C₃H₆— or —C₄H₈—), such as —CH₂—.
R⁵⁶ each independently has a 3- to 20-membered ring structure containing at least one or more oxygen atoms in the ring structure.
R⁵⁶ contains preferably 1 to 10 oxygen atoms, and may contain 1 to 8 oxygen atoms, and may contain 1 to 6 oxygen atoms, such as 2 oxygen atoms, in the ring structure.
R⁵⁶ may have a substituent at an atom forming the ring structure. Preferably, R⁵⁶ has no substituent at an atom forming the ring structure.

In one embodiment, R⁵⁶ has an oxygen atom and a carbon atom as ring-member atoms that contains preferably 1 to 8 oxygen atoms and 2 to 16 carbon atoms, and more preferably 1 to 6 oxygen atoms and 2 to 12 carbon atoms.

In one embodiment, R⁵⁶ is a monovalent organic group derived from crown ether. The term “crown ether” refers to macrocyclic ether group of (—CH₂—CH₂—O—)ₘ wherein m is, for example, an integer of 4 to 6.

For example, R⁵⁶ may be the following structures. The part provided with * in the following structures connects to R⁵⁵.

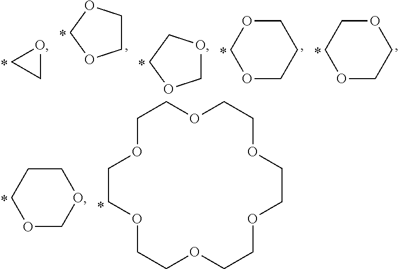

Preferably,
R² is each independently represented by —CH₂—R⁵²—O—(R⁵³—O)ₙ₄—R⁵⁴,
R⁵² is a single bond, R⁵³ is CH₂, n4 is an integer of 1 to 10 (preferably, n4 is an integer of 1 to 2), and R⁵⁴ is each independently a C₁₋₄ alkyl group;
R² is each independently represented by —CH₂—R⁵²—O—(R⁵³—O)ₙ₄—R⁵⁴,
R⁵² is CH₂, R⁵³ is CH₂CH₂, n4 is an integer of 1 to 10 (preferably, n4 is an integer of 1 to 6), and R⁵⁴ is each independently a C₁₋₄ alkyl group;
R² is each independently represented by —CH₂—R⁵²—O—(R⁵³—O)ₙ₄—R⁵⁴, and
R⁵² is each independently a single bond or a C₁₋₁₀ alkylene group, n4 is 0, and R⁵⁴ is each independently a C₁₋₄ alkyl group; or
R² is each independently represented by —CH₂—R⁵⁵—R⁵⁶,
R⁵⁵ is each independently a single bond or a C₁₋₁₀ alkylene group (preferably, R⁵⁵ is a single bond), and R⁵⁶ each independently has a ring structure containing 1 to 8 oxygen atoms and 2 to 16 carbon atoms (preferably a ring structure containing 1 to 6 oxygen atoms and 2 to 12 carbon atoms).

In one embodiment, the fluoropolyether group-containing silane compound is a compound represented by formula (A1).

In another embodiment, the fluoropolyether group-containing silane compound is a compound represented by formula (A2).

The fluoropolyether group-containing silane compound represented by the formula (A1) or (A2) can be produced by combining known methods.

As one embodiment, a method suitable for producing the fluoropolyether group-containing silane compound of the present disclosure represented by formula (A1) will now be described below.

The fluoropolyether group-containing silane compound of the present disclosure can be produced by, for example, a method comprising reacting a compound represented by formula (B2):

Y¹R¹N—X^{2″}—(C(X^{3′}—CH═CH₂)₂R²)_{β} (B2)

or an acid salt thereof with HSiM₃ (wherein M is each independently a halogen atom (i.e., I, Br, Cl, or F) or a C₁₋₆ alkoxy group, preferably a halogen atom, and more preferably Cl) and, as desired, a compound represented by R^{b1}L′ (R^{b1} has the same definition as above, and L′ represents a group capable of binding to R^{b1}) and/or a compound represented by R^{c1}L″ (R^{c1} has the same definition as above, and L″ represents a group capable of binding to R^{c1}).

R¹ in formula (B2) corresponds to R¹ in formula (A1) or (A2).

Y¹ is a hydrogen atom, or a protective group for an amino group (e.g., a tert-butoxycarbonyl group, a benzyloxycarbonyl group, a 9-fluorenylmethyloxycarbonyl group, an allyloxycarbonyl group, a 2,2,2-trichloroethoxycarbonyl group, a 2-(trimethylsilyl)ethoxycarbonyl group, an acetyl group, a trifluoroacetyl group, a methanesulfonyl group, a benzenesulfonyl group, a p-toluenesulfonyl group, a 2-nitrobenzenesulfonyl group, a trifluoromethanesulfonyl group, or a (2-trimethylsilyl)ethanesulfonyl group).

At least one of Y¹ and R¹ is a hydrogen atom.

In one embodiment, Y¹ is a hydrogen atom. In one embodiment, Y¹ is a protective group.

In formula (B2), X^{2″} is a single bond or a di- to decavalent organic group. X^{2″} corresponds to X² in formula (A1) or (A2).
X^{3′} is each independently a single bond, an oxygen atom, or a divalent organic group. X³ in formulae (A1) and (A2) is formed from —X^{3′}—CH═CH₂. X^{3′} is preferably a C₁₋₂ alkylene group.
R² and β correspond to R² and β, respectively, in formula (A1) or (A2).

In one embodiment, each of R¹ and Y¹ in formula (B2) is a hydrogen atom.

Examples of the acid salt of the compound represented by formula (B2) include hydrochloric acid salts.

The above step is preferably carried out in a suitable solvent in the presence of a suitable catalyst.

Examples of the suitable catalyst include, but are not limited to, Pt, Pd, and Rh. Such a catalyst may be in any form, e.g., in the form of a complex.

The suitable solvent is not limited as long as it does not adversely affect the reaction, and examples include 1,3-bis(trifluoromethyl)benzene, perfluorobutyl ethyl ether, perfluorohexyl methyl ether, perfluorohexane, and hexafluorobenzene.

The reaction temperature in the reaction is not limited, and is usually 0 to 100° C. and preferably 50 to 80° C.; the reaction time is not limited, and is usually 60 to 600 minutes and preferably 120 to 300 minutes; and the reaction pressure is not limited, and is −0.2 to 1 MPa (gauge pressure) and conveniently is atmospheric pressure.

The compound represented by the formula (B2) can be obtained by, for example, but not limited to, exposing a compound represented by formula (B1):

NC—X^{2′}—(C(X^{3′}—CH═CH₂)₂R²)_{β} (B1)

to reducing conditions to convert the compound into an amine, followed by application of any of various modification reactions if necessary.

X^{2′} is a single bond or a di- to decavalent organic group. HR¹N—X^{2″}— in formula (B2) is formed from NC—X^{2′}—. X^{3′}, R² and β have the same definition as above.

The compound represented by the formula (B1) can be synthesized by, for example, but not limited to, reacting a compound represented by the formula:

NC—X^{2′}—CH₂—COOR^{X}

with a base and an alkenyl halide represented by Hal-X^{3′}—(CH═CH₂) to synthesize a compound represented by formula (B0):

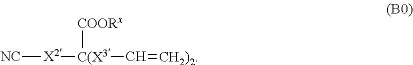

converting the —COOR^{X} moiety into —H by a decarboxylation reaction, and then reacting with a base and an appropriate (oxy)alkyl halide. Hal is a halogen, for example, Br, and Rx is a methyl group or an ethyl group. X^{2′} and X^{3′} have the same definition as above.

The present disclosure provides a compound represented by formula (B1):

NC—X^{2′}—(C(X^{3′}—CH═CH₂)₂R²)_{β} (B1)

that is, an intermediate in the above production method. X^{2′}, X^{3′}, R² and β have the same definition as above.

In one embodiment, in the compound represented by formula (B1),
β is an integer of 1 to 9;
X^{2′} is a single bond or a di- to decavalent organic group;
X^{3′} is each independently a C₁₋₂ alkylene group;
R^{2′} is each independently represented by —CH₂—R⁵¹;
R⁵¹ is each independently a monovalent organic group having an oxyalkylene group.

In one embodiment, β is 1, and
X^{2′} is a single bond.

In one embodiment, β is 1, and
X^{2′} is a divalent organic group represented by the following formula:
—(R^{80″})_{p4″}—. R^{80″} is each independently a C₁₋₄ alkylene group (e.g., C₁₋₃ alkylene group) optionally substituted with one or more fluorine atoms, or a phenylene group, and p4″ is 1 or 2.

In one embodiment, X^{2′} is a C₁₋₄ alkylene group optionally substituted with one or more fluorine atoms, such as a C₁₋₃ alkylene group optionally substituted with one or more fluorine atoms.

The present disclosure provides a compound represented by formula (B2):

Y¹R¹N—X^{2″}—(C(X^{3′}—CH═CH₂)₂R²)_{β} (B2)

and an acid salt thereof, that is, an intermediate in the above production method. Y¹, R¹, X^{2″}, X^{3′}, R² and β have the same definition as above.

In one embodiment, in the compound represented by formula (B2),
R¹ corresponds to R¹ in formula (A1) or (A2);
β is an integer of 1 to 9, and preferably 1;
X^{2″} is a single bond or a di- to decavalent organic group, and preferably a divalent organic group, such as a divalent organic group represented by the following formula:

—(R^{80″′})_{p4″′}—.
R^{80″′} each independently represents a C₁₋₄ alkylene group optionally substituted with one or more fluorine atoms, or a phenylene group, and
p4″′ is 1 or 2.

In one embodiment, in the compound represented by formula (B2),
R¹ corresponds to R¹ in formula (A1) or (A2);
β is an integer of 1 to 9, and preferably 1;
X^{2″} is a single bond or a di- to decavalent organic group, and preferably a divalent organic group, such as a divalent organic group represented by the following formula:

—(R^{80″′})_{p4″′}—;
R^{80′″} each independently represents a C₁₋₄ alkylene group optionally substituted with one or more fluorine atoms, or a phenylene group;
p4″′ is 1 or 2;
X^{3′} is each independently a C₁₋₂ alkylene group;
R² is each independently represented by —CH₂—R⁵¹;
R⁵¹ is each independently a monovalent organic group having an oxyalkylene group. R⁵¹ has the same definition as above.

In one embodiment, R^{80″′} is each independently a C₁₋₄ alkylene group optionally substituted with one or more fluorine atoms, for example, C₁₋₄ alkylene group.

In one embodiment, R^{80″′} is a phenylene group.

In one embodiment, the above intermediate is a compound represented by formula (B2).

In one embodiment, the intermediate is a compound represented by formula (B2), and Y¹ is a hydrogen atom.

In one embodiment, the intermediate is a compound represented by formula (B2), and Y¹ is a protective group. Examples of the protective group include a tert-butoxycarbonyl group, a benzyloxycarbonyl group, a 9-fluorenylmethyloxycarbonyl group, an allyloxycarbonyl group, a 2,2,2-trichloroethoxycarbonyl group, a 2-(trimethylsilyl)ethoxycarbonyl group, an acetyl group, a trifluoroacetyl group, a methanesulfonyl group, a benzenesulfonyl group, a p-toluenesulfonyl group, a 2-nitrobenzenesulfonyl group, a trifluoromethanesulfonyl group, or a (2-trimethylsilyl)ethanesulfonyl group), with tert-butoxycarbonyl group being preferable. In the present embodiment, R¹ is a hydrogen atom.

In one embodiment, the intermediate is an acid salt of the compound represented by formula (B2). Examples of the acid salt include hydrochloric acid salts and the like, with hydrochloric acid salts being preferable. In the present embodiment, at least one of R¹ and Y¹ is a hydrogen atom. In one embodiment, Y¹ is a hydrogen atom.

### (Surface-Treating Agent)

The fluoropolyether group-containing silane compound may be used as a surface-treating agent.

The surface-treating agent of the present disclosure can contribute to formation of a surface-treating layer having good ultraviolet durability, water-repellency, oil-repellency, antifouling property (for example, preventing grime such as fingerprints from adhering), chemical resistance, hydrolysis resistance, a lubricity suppressing effect, high friction durability, heat resistance, moisture-proof property, and the like.

In one embodiment, the surface-treating agent contains the fluoropolyether group-containing silane compound represented by formula (A1) or (A2).

In one embodiment, the surface-treating agent contains at least one selected from the group consisting of the fluoropolyether group-containing silane compound represented by formula (A1) or (A2), and a condensation product in which the fluoropolyether group-containing silane compound is at least partially condensed. The condensation product is a partial condensation product (a hydrolysis condensation product) obtained by condensing a hydroxyl group of the fluoropolyether group-containing silane represented by formula (A1) or (A2) and/or a hydroxyl group obtained by partially hydrolyzing a hydrolyzable group by a known method in advance.

Any of hydrolysis condensation catalysts, for example, organotin compounds (dibutyltin dimethoxide, dibutyltin dilaurate and the like), organotitanium compounds (tetra-n-butyl titanate and the like), organic acids (acetic acid, methanesulfonic acid, fluorine-modified carboxylic acid and the like), and inorganic acids (hydrochloric acid, sulfuric acid and the like) may be added to the surface-treating agent as necessary. Among them, acetic acid, tetra-n-butyl titanate, dibutyltin dilaurate, fluorine-modified carboxylic acid and the like are particularly desirable.

The amount of the hydrolysis condensation catalyst added is a catalytic amount, and is typically 0.01 to 5 parts by mass, in particular, 0.1 to 1 parts by mass, based on 100 parts by mass of the fluoropolyether group-containing silane compound and/or a partial condensation product (a hydrolysis condensation product) thereof.

In another embodiment, the surface-treating agent of the present disclosure contains the fluoropolyether group-containing silane compound represented by formula (A1) and the fluoropolyether group-containing silane compound represented by formula (A2). The composition (e.g., surface-treating agent) of the present embodiment can contribute to the formation of a cured layer having good friction durability. The friction durability of a cured layer formed using the composition of the present embodiment is improved, and the lubricity of the surface of the cured layer is improved. It is considered that in the composition of the present embodiment, the secondary structure of the R^{F} moiety is likely to be a helical structure, and the polymer density per unit area and the crosslink density of the silane coupling agent increase, so that the strength of the cured layer is enhanced.

In one embodiment, the lower limit of the ratio (molar ratio) of the amount of the fluoropolyether group-containing silane compound represented by the formula (A2) to the total amount of the fluoropolyether group-containing silane compound represented by the formula (A1) and the fluoropolyether group-containing silane compound represented by the formula (A2) in the composition of the present disclosure (for example, a surface-treating agent) may be preferably 0.001, more preferably 0.002, even more preferably 0.005, still more preferably 0.01, particularly preferably 0.02, and especially 0.05. The upper limit of the ratio (molar ratio) of the amount of the fluoropolyether group-containing silane compound represented by the formula (A2) to the total amount of the fluoropolyether group-containing silane compound represented by the formula (A1) and the fluoropolyether group-containing silane compound represented by the formula (A2) may be preferably 0.70, more preferably 0.60, more preferably 0.50, even more preferably 0.40, and still more preferably 0.30, for example, 0.20, specifically 0.10. The ratio (molar ratio) of the amount of the fluoropolyether group-containing compound represented by the formula (A2) to the total amount of the fluoropolyether group-containing silane compound represented by the formula (A1) and the fluoropolyether group-containing silane compound represented by the formula (A2) may be 0.001 or more and 0.70 or less, may be 0.001 or more and 0.60 or less, may be 0.001 or more and 0.50 or less, may be 0.002 or more and 0.40 or less, may be 0.005 or more and 0.30 or less, and may be 0.01 or more and 0.20 or less, and is, for example, 0.02 or more and 0.20 or less (specifically, 0.15 or less) or 0.05 or more and 0.20 or less (specifically, 0.15 or less).

In one embodiment, the lower limit of the ratio (molar ratio) of the amount of the fluoropolyether group-containing silane compound represented by the formula (A1) to the total amount of the fluoropolyether group-containing silane compound represented by the formula (A1) and the fluoropolyether group-containing silane compound represented by the formula (A2) in the composition of the present disclosure (for example, a surface-treating agent) may be preferably 0.001, more preferably 0.002, even more preferably 0.005, still more preferably 0.01, particularly preferably 0.02, and especially 0.05. The upper limit of the ratio (molar ratio) of the amount of the fluoropolyether group-containing silane compound represented by the formula (A1) to the total amount of the fluoropolyether group-containing silane compound represented by the formula (A1) and the fluoropolyether group-containing silane compound represented by the formula (A2) may be preferably 0.70, more preferably 0.60, more preferably 0.50, even more preferably 0.40, and still more preferably 0.30, for example, 0.20, specifically 0.10. The ratio (molar ratio) of the amount of the fluoropolyether group-containing compound represented by the formula (A1) to the total amount of the fluoropolyether group-containing silane compound represented by the formula (A1) and the fluoropolyether group-containing silane compound represented by the formula (A2) may be 0.001 or more and 0.70 or less, may be 0.001 or more and 0.60 or less, may be 0.001 or more and 0.50 or less, may be 0.002 or more and 0.40 or less, may be 0.005 or more and 0.30 or less, and may be 0.01 or more and 0.20 or less, and is, for example, 0.02 or more and 0.20 or less (specifically, 0.15 or less) or 0.05 or more and 0.20 or less (specifically, 0.15 or less).

The surface-treating agent may be diluted with a solvent. Such a solvent is not limited, and examples thereof include:

a fluorine atom-containing solvent selected from the group consisting of perfluorohexane, CF₃CF₂CHCl₂, CF₃CH₂CF₂CH₃, CF₃CHFCHFC₂F₅, 1,1,1,2,2,3,3,4,4,5,5,6,6-tridecafluorooctane, 1,1,2,2,3,3,4-heptafluorocyclopentane ((Zeorora H (trade name) or the like), C₄F₉OCH₃, C₄F₉OC₂H₅, CF₃CH₂OCF₂CHF₂, C₆F₁₃CH═CH₂, C₆F₁₃OCH₃, xylene hexafluoride, perfluorobenzene, methyl pentadecafluoroheptyl ketone, trifluoroethanol, pentafluoropropanol, hexafluoroisopropanol, HCF₂CF₂CH₂OH, methyl trifluoromethanesulfonate, trifluoroacetic acid, CF₃O(CF₂CF₂O)ₘ₁(CF₂O)ₙ₁CF₂CF₃: wherein m1 and n1 are each independently an integer of 0 or more and 1000 or less and the occurrence order of the respective repeating units in parentheses with m1 or n1 is not limited in the formula, provided that the sum of m1 and n1 is 1 or more; 1,1-dichloro-2,3,3,3-tetrafluoro-1-propene, 1,2-dichloro-1,3,3,3-tetrafluoro-1-propene, 1,2-dichloro-3,3,3-trifluoro-1-propene, 1,1-dichloro-3,3,3-trifluoro-1-propene, 1,1,2-trichloro-3,3,3-trifluoro-1-propene, and 1,1,1,4,4,4-hexafluoro-2-butene. These solvents can be used alone or as a mixture of two or more types.

The content of moisture contained in the solvent is preferably 20 ppm by mass or less. The content of moisture can be measured by use of a Karl Fischer method. The content of moisture can be in the range to thereby allow storage stability of the surface-treating agent to be enhanced.

The surface-treating agent may further contain a (non-reactive) fluoropolyether compound, preferably a perfluoro(poly)ether compound, that can be interpreted as fluorine-containing oil (hereafter referred to as “fluorine-containing oil”).

The fluorine-containing oil is not limited, and examples thereof include a compound (perfluoro(poly)ether compound) represented by the following general formula (1):

Rf⁵—(OC₄F₈)_{a′}—(OC₃F₆)_{b′}—(OC₂F₄)_{c′}—(OCF₂)_{d′}—Rf⁶ (1)
wherein Rf⁵ represents an alkyl group having 1 to 16 carbon atoms optionally substituted with one or more fluorine atoms (preferably, a C₁₋₁₆ perfluoroalkyl group), Rf⁶ represents an alkyl group having 1 to 16 carbon atoms optionally substituted with one or more fluorine atoms (preferably, a C₁₋₁₆ perfluoroalkyl group), a fluorine atom, or a hydrogen atom, and Rf⁵ and Rf⁶ are more preferably, each independently, a C₁₋₃ perfluoroalkyl group; and
a′, b′, c′ and d′ represent the numbers of four repeating units in perfluoro(poly)ether constituting the main backbone of the polymer, respectively, and are mutually independently an integer of 0 or more and 300 or less, the sum of a′, b′, c′ and d′ is at least 1, preferably 1 to 300, and more preferably 20 to 300. The occurrence order of the respective repeating units in parentheses provided with a subscript a′, b′, c′, or d′ is not limited in the formula. The repeating unit has at least one branched structure. That is to say, the repeating unit has at least one CF₃ terminal (specifically —CF₃, —C₂F₅, or the like, and more specifically —CF₃). Examples of the repeating unit having a branched structure may include —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C₂F₅)CF₂)— and —(OCF₂CF(C₂F₅))— as —(OC₄F₈)—; and —(OCF(CF₃)CF₂)— and —(OCF₂CF(CF₃))— as —(OC₃F₆)—; and —(OCF(CF₃)) as —(OC₂F₄)—.

Examples of the perfluoro(poly)ether compound represented by the general formula (1) include a compound represented by any of the following general formulae (1a) and (1b) (which may be adopted singly or as a mixture of two or more kinds thereof).

Rf⁵—(OCF(CF₃)CF₂)_{b″}—Rf⁶ (1a)

Rf⁵—(OC₄F₈)_{a″}—(OC₃F₆)_{b}″—(OCF(CF₃))_{c″}—(OCF₂)_{d″}—Rf⁶ (1b)

In these formulae, Rf⁵ and Rf⁶ are as described above; in formula (1a), b″ is an integer of 1 or more and 100 or less; and, in formula (1b), a″ and b″ are each independently an integer of 1 or more and 30 or less, c″ and d″ are each independently an integer of 1 or more and 300 or less. The occurrence order of the respective repeating units in parentheses provided with subscript a″, b″, c″, or d″ is not limited in the formulae. —(OC₄F₈)— and —(OC₃F₆)— have a branched structure.

The fluorine-containing oil may have a number average molecular weight of 1,000 to 30,000. In particular, the number average molecular weight of the compound represented by formula (1a) is preferably 2,000 to 8,000. The compound can have such a number average molecular weight, thereby allowing good friction durability to be obtained. In one embodiment, the number average molecular weight of the compound represented by formula (1b) is 3,000 to 8,000. In another embodiment, the number average molecular weight of the compound represented by formula (1b) is 8,000 to 30,000.

The surface-treating agent can contain, for example, 0 to 500 parts by mass, preferably 0 to 100 parts by mass, more preferably 1 to 50 parts by mass, even more preferably 1 to 5 parts by mass of the fluorine-containing oil based on 100 parts by mass of the fluoropolyether group-containing silane compound.

The surface-treating agent can contain, for example, 0 to 30 mass %, preferably 0 to 20 mass %, more preferably 0 to 10 mass % of the fluorine-containing oil based on the total amount of the fluoropolyether group-containing silane compound and the fluorine-containing oil.

The fluorine-containing oil may be a compound represented by the general formula Rf′—F, wherein Rf′ is a C₅₋₁₆ perfluoroalkyl group, from another viewpoint. The fluorine-containing oil may be a chlorotrifluoroethylene oligomer. The compound represented by Rf′—F and the chlorotrifluoroethylene oligomer are preferable in that high affinity with the perfluoro(poly)ether group-containing silane compound where Rf is a C₁₋₁₆ perfluoroalkyl group is obtained.

The fluorine-containing oil contributes to increasing the surface lubricity of the surface-treating layer.

In one embodiment, the surface-treating agent of the present disclosure contains the compound represented by formula (A1), and a fluorine-containing oil.

In one embodiment, the surface-treating agent of the present disclosure contains the compound represented by formula (A2), and a fluorine-containing oil.

In one embodiment, the surface-treating agent of the present disclosure contains the compound represented by formula (A1), the compound represented by formula (A2) and a fluorine-containing oil.

In one embodiment, the surface-treating agent contains preferably 0.001 to 70 mol % of the compound represented by formula (A2) and 0.001 to 50 mol % of the fluorine-containing oil, more preferably 0.01 to 60 mol % of the compound represented by formula (A2) and 0.01 to 40 mol % of the fluorine-containing oil, and still more preferably 0.1 to 50 mol % of the compound represented by formula (A2) and 0.1 to 30 mol % of the fluorine-containing oil, based on the total amount of the compound represented by formula (A1), the compound represented by formula (A2) and the fluorine-containing oil.

In one embodiment, the surface-treating agent contains preferably 0.001 to 70 mol % of the compound represented by formula (A1) and 0.001 to 50 mol % of the fluorine-containing oil, more preferably 0.01 to 60 mol % of the compound represented by formula (A1) and 0.01 to mol % of the fluorine-containing oil, and still more preferably 0.1 to 50 mol % of the compound represented by formula (A1) and 0.1 to 30 mol % of the fluorine-containing oil, based on the total amount of the compound represented by formula (A1), the compound represented by formula (A2) and the fluorine-containing oil.

In addition to the fluoropolyether group-containing silane compound represented by formula (A1) or (A2), other components may be contained in the surface-treating agent. Such other component is not limited, and examples thereof include a (unreactive) silicone compound which can be understood as a silicone oil (hereinafter, referred to as “silicone oil”), a catalyst, a lower alcohol, a transition metal, a halide ion, and a compound containing an atom having an unshared electron pair in a molecular structure.

For example, the silicone oil may be linear or cyclic silicone oil having 2,000 or fewer siloxane bonds. The linear silicone oil may be so-called straight silicone oil or modified silicone oil. Examples of the straight silicone oil include dimethyl silicone oil, methyl phenyl silicone oil, and methyl hydrogen silicone oil. Examples of the modified silicone oil include those obtained by modifying straight silicone oil with alkyl, aralkyl, polyether, higher fatty acid ester, fluoroalkyl, amino, epoxy, carboxyl, alcohol, or the like. Examples of the cyclic silicone oil include cyclic dimethylsiloxane oil.

In the surface-treating agent, such a silicone oil may be contained in an amount of, for example, 0 to 50 parts by mass, and preferably 0 to 5 parts by mass, based on 100 parts by mass of the above fluoropolyether group-containing silane compound (in the case of two or more kinds, the total thereof, and the same applies below).

Silicone oil contributes to increasing the surface lubricity of the surface-treating layer.

Examples of the catalyst include acids (such as acetic acid and trifluoroacetic acid), bases (such as ammonia, triethylamine, and diethylamine), and transition metals (such as Ti, Ni, and Sn).

The catalyst promotes hydrolysis and dehydration condensation of the fluorine-containing silane compound, and promotes formation of a surface-treating layer.

Examples of the lower alcohol as other component described above include an alcohol compound having 1 to 6 carbon atoms.

Examples of the transition metal include platinum, ruthenium, and rhodium.

Examples of the halide ion include a chloride ion.

Examples of the compound containing an atom having an unshared electron pair in a molecular structure include diethylamine, triethylamine, aniline, pyridine, hexamethylphosphoramide, N,N-diethylacetamide, N,N-diethylformamide, N,N-dimethylacetamide, N-methylformamide, N,N-dimethylformamide, N-methylpyrrolidone, tetramethylurea, dimethyl sulfoxide (DMSO), tetramethylene sulfoxide, methylphenyl sulfoxide, and diphenyl sulfoxide. Among such compounds, dimethyl sulfoxide or tetramethylene sulfoxide is preferably used.

Examples of other components include, in addition to those described above, tetraethoxysilane, methyltrimethoxysilane, 3-aminopropyltrimethoxysilane, 3-glycidoxypropyltrimethoxysilane, and methyltriacetoxysilane.

In one embodiment, the surface-treating agent does not include any fluorine-containing oil, silicone oil, catalyst, lower alcohol, transition metal, halide ion, and compound containing an atom having an unshared electron pair in a molecular structure, as other component above.

In one embodiment, the compound represented by formula (A2) may be contained in an amount of 70 mol % or less, may be contained in an amount of 60 mol % or less, may be contained in an amount of 50 mol % or less, may be contained in an amount of 0.001 mol % or more, may be contained in an amount of 0.01 mol % or more, and may be contained in 0.1 mol % or more, for example, based on the total amount of the compound represented by formula (A1), the compound represented by formula (A2) and the fluorine-containing oil. The compound represented by formula (A2) may be contained in an amount of 1 to 70 mol %, and may be contained in an amount of 5 to 50 mol %, for example, based on the total amount of the compound represented by formula (A1), the compound represented by formula (A2) and the fluorine-containing oil.

In one embodiment, the composition (e.g., surface-treating agent) of the present disclosure contains the compound represented by formula (A1), the compound represented by formula (A2) and a fluorine-containing oil.

In the present embodiment, the fluorine-containing oil may be contained in an amount of 0.001 mol % or more, may be contained in an amount of 0.01 mol % or more, may be contained in an amount of 1.0 mol % or more, may be contained in an amount of 50 mol % or less, and may be contained in an amount of 40 mol % or less, may be contained in an amount of 30 mol % or less, and may be contained in an amount of 10 mol % or less, for example, based on the total amount of the compound represented by formula (A1), the compound represented by formula (A2) and the fluorine-containing oil. The fluorine-containing oil may be contained in an amount of 0.001 to 50 mol %, and may be contained in an amount of 0.01 to 40 mol %, for example, based on the total amount of the compound represented by formula (A1), the compound represented by formula (A2) and the fluorine-containing oil.

In the present embodiment, the surface-treating agent contains preferably 0.001 to 70 mol % of the compound represented by formula (A2) and 0.001 to 50 mol % of the fluorine-containing oil, more preferably 0.01 to mol % of the compound represented by formula (A2) and to 40 mol % of the fluorine-containing oil, and still more preferably 0.1 to 50 mol % of the compound represented by formula (A2) and 0.1 to 30 mol % of the fluorine-containing oil, based on the total amount of the compound represented by formula (A1), the compound represented by formula (A2) and the fluorine-containing oil.

The composition (e.g., surface-treating agent) of the present embodiment can contribute to the formation of a cured layer having good friction durability. Further, the friction durability of a cured layer formed using the composition of the present embodiment is improved, and the lubricity of the surface of the cured layer is improved. It is considered that in the composition of the present embodiment, the secondary structure of the R^{F} moiety is likely to be a helical structure, and the polymer density per unit area and the crosslink density of the silane coupling agent increase, so that the strength of the cured layer is enhanced.

In one embodiment, the composition (e.g., surface-treating agent) of the present disclosure contains the compound represented by formula (A1), the compound represented by formula (A2) and a fluorine-containing oil.

In the present embodiment, the compound represented by formula (A2) may be contained in an amount of 0.001 mol % or more and less than 50 mol %, may be contained in an amount of 0.1 mol % or more and less than 50 mol %, may be contained in an amount of 1 mol % or more and less than 50 mol %, and may be contained in an amount of, for example, 10 mol % or more and less than 50 mol %, based on the total amount of the compound represented by formula (A1) and the compound represented by formula (A2).

In one embodiment, the composition (e.g., surface-treating agent) of the present disclosure contains the compound represented by formula (A1), the compound represented by formula (A2) and a fluorine-containing oil.

In the present embodiment, the compound represented by formula (A1) may be contained in an amount of 0.001 mol % or more and less than 50 mol %, may be contained in an amount of 0.1 mol % or more and less than 50 mol %, may be contained in an amount of 10 mol % or more and less than 50 mol %, and may be contained in an amount of, for example, 20 mol % or more and less than 50 mol %, or 30 mol % or more and less than 50 mol %, based on the total amount of the compound represented by formula (A1) and the compound represented by formula (A2).

In one embodiment, the composition (e.g., surface-treating agent) of the present disclosure contains the compound represented by formula (A1), the compound represented by formula (A2) and a fluorine-containing oil.

In the present embodiment, the compound represented by formula (A2) may be contained in an amount of 35 mol % or more and less than 65 mol %, and may be contained in an amount of 40 mol % or more and less than 60 mol %, based on the total amount of the compound represented by formula (A1) and the compound represented by formula (A2).

In one embodiment, the surface-treating agent of the present disclosure contains the fluoropolyether group-containing silane compound represented by formula (A1) or (A2), and is free of the fluorine-containing oil which is the other component (for example, the content of the fluorine-containing oil is 1 part by mass or less, and more specifically 0 parts by mass, based on 100 parts by mass of the surface-treating agent).

The composition of the present disclosure can be used as a surface-treating agent for surface treatment of a substrate.

The surface-treating agent of the present disclosure may be used as, for example, an antifouling coating agent or a water-proof coating agent.

The surface-treating agent of the present disclosure can be formed into pellets by impregnating with the composition a porous material such as a porous ceramic material or a metal fiber such as a fiber obtained by, for example, solidifying steel wool in a cotton-like form. Such pellets can be used in, for example, vacuum deposition.

### (Article)

Hereinafter, an article of the present disclosure will be described.

The article of the present disclosure includes: a substrate; and a layer (a surface-treating layer) on the surface of the substrate, where the layer is formed of the fluoropolyether group-containing silane compound of the present disclosure or a surface-treating agent containing the fluoropolyether group-containing silane compound (hereinafter, these are simply referred to as a “surface-treating agent of the present disclosure”, collectively).

The substrate usable herein may be composed of any suitable material such as glass, resin (which may be natural or synthetic resin such as a commonly used plastic material, and may be in the form of a plate, a film, or the like), metal, ceramics, semiconductors (such as silicon and germanium), fiber (such as woven fabric and nonwoven fabric), fur, leather, wood, pottery, stone, and building materials.

For example, when the article to be produced is an optical member, the material constituting the surface of the substrate may be a material for an optical member, such as glass or a transparent plastic. When the article to be produced is an optical member, some layer (or film) such as a hard coat layer or an antireflection layer may be formed on the surface (the outermost layer) of the substrate. The antireflection layer may be any of a single-layer antireflection layer and a multi-layer antireflection layer. Examples of inorganic substances usable in the antireflection layer include SiO₂, SiO, ZrO₂, TiO₂, TiO, Ti₂O₃, Ti₂O₅, Al₂O₃, Ta₂O₅, CeO₂, MgO, Y₂O₃, SnO₂, MgF₂, and WO₃. One of these inorganic substances may be used singly, or two or more may be used in combination (e.g., as a mixture). In the case of a multi-layer antireflection layer, SiO₂ and/or SiO is preferably used in the outermost layer thereof. When the article to be produced is an optical glass component for a touch panel, a part of the surface of the substrate (glass) may have a transparent electrode such as a thin film in which indium tin oxide (ITO), indium zinc oxide, or the like is used. The substrate, according to its specific configuration or the like, may have an insulating layer, an adhesive layer, a protecting layer, a decorated frame layer (I-CON), an atomizing film layer, a hard coating layer, a polarizing film, a phase difference film, a liquid crystal display module, or the like.

The shape of the substrate is not limited. The surface region of the substrate on which a layer formed by the surface-treating agent of the present disclosure is to be formed is at least a part of the substrate surface, and may be suitably determined according to the application, specific specifications, and the like of an article to be produced.

The substrate, or at least the surface portion thereof, may be composed of a material originally having a hydroxyl group. Examples of the material include glass as well as metal (in particular, base metal) wherein a natural oxidized film or a thermal oxidized film is formed on the surface, ceramics, semiconductors, and the like. Alternatively, when the substrate has an insufficient amount of a hydroxyl group or when the substrate originally does not have a hydroxyl group as in resin and the like, a pre-treatment may be performed on the substrate to thereby introduce or increase a hydroxyl group on the surface of the substrate. Examples of such a pre-treatment include a plasma treatment (e.g., corona discharge) and ion beam irradiation. The plasma treatment can be suitably utilized to not only introduce or increase a hydroxyl group on the substrate surface, but also clean the substrate surface (remove foreign matter and the like). Another example of such a pre-treatment includes a method wherein a monolayer of a surface adsorbent having a carbon-carbon unsaturated bonding group is formed on the surface of the substrate by a LB method (a Langmuir-Blodgett method), a chemical adsorption method, or the like beforehand, and, thereafter, cleaving the unsaturated bond under an atmosphere containing oxygen, nitrogen, or the like.

Alternatively, the substrate, or at least a surface portion thereof, may be composed of a silicone compound having one or more other reactive groups such as a Si—H group, or a material containing alkoxysilane.

Then, a layer of the surface-treating agent of the present disclosure is formed on the surface of the substrate, this layer is post-treated as necessary, and thereby a layer is formed from the surface-treating agent of the present disclosure.

The layer of the surface-treating agent of the present disclosure can be formed by applying the above surface-treating agent on the surface of the substrate such that the composition coats the surface. The coating method is not limited. For example, a wet coating method and a dry coating method can be used.

Examples of the wet coating method include dip coating, spin coating, flow coating, spray coating, roll coating, gravure coating, and similar methods.

Examples of the dry coating method include deposition (usually, vacuum deposition), sputtering, CVD, and similar methods. Specific examples of the deposition method (usually, a vacuum deposition method) include resistive heating, electron beam, high-frequency heating using microwave or the like, ion beam, and similar methods. Specific examples of the CVD method include plasma-CVD, optical CVD, thermal CVD, and similar methods.

Furthermore, coating by an atmospheric pressure plasma method can be performed.

When using the wet coating method, the surface-treating agent of the present disclosure can be applied to the substrate surface after being diluted with a solvent. From the viewpoint of the stability of the surface-treating agent of the present disclosure and the volatility of solvents, the following solvents are preferably used: perfluoroaliphatic hydrocarbons having 5 to 12 carbon atoms (such as perfluorohexane, perfluoromethylcyclohexane, and perfluoro-1,3-dimethylcyclohexane); polyfluoroaromatic hydrocarbons (such as bis(trifluoromethyl)benzene); polyfluoroaliphatic hydrocarbons (such as C₆F₁₃CH₂CH₃ (such as Asahiklin (R) AC-6000 manufactured by Asahi Glass Co., Ltd., and 1,1,2,2,3,3,4-heptafluorocyclopentane (such as Zeorora (R) H manufactured by Zeon Corporation); alkyl perfluoroalkyl ethers (the perfluoroalkyl group and the alkyl group may be linear or branched) such as hydrofluoroether (HFE) (such as perfluoropropylmethyl ether (C₃F₇OCH₃) (such as Novec™ 7000 manufactured by Sumitomo 3M Limited), perfluorobutyl methyl ether (C₄F₉OCH₃) (such as Novec™ 7100 manufactured by Sumitomo 3M Limited), perfluorobutyl ethyl ether (C₄F₉OC₂H₅) (such as Novec™ 7200 manufactured by Sumitomo 3M Limited), and perfluorohexyl methyl ether (C₂F₅CF(OCH₃)C₃F₇) (such as Novec™ 7300 manufactured by Sumitomo 3M Limited), or CF₃CH₂OCF₂CHF₂ (such as Asahiklin (R) AE-3000 manufactured by Asahi Glass Co., Ltd.)). One of these solvents can be used singly, or two or more can be used as a mixture. In particular, hydrofluoroether is preferable, and perfluorobutyl methyl ether (C₄F₉OCH₃) and/or perfluorobutyl ethyl ether (C₄F₉OC₂H₅) is particularly preferable.

When using the dry coating method, the surface-treating agent of the present disclosure may be directly subjected to the dry coating method, or may be diluted with the above solvent before being subjected to the dry coating method.

A layer of the surface-treating agent is preferably formed such that the surface-treating agent of the present disclosure coexists with a catalyst for hydrolysis and dehydrative condensation in the layer. Conveniently, in the case of a wet coating method, the surface-treating agent of the present disclosure is diluted with a solvent, and then, immediately before application to the substrate surface, a catalyst may be added to the diluted solution of the surface-treating agent of the present disclosure. In the case of a dry coating method, the surface-treating agent of the present disclosure to which a catalyst has been added is directly used in a deposition (usually vacuum deposition) treatment, or a pellet-like material may be used in a deposition (usually vacuum deposition) treatment, wherein the pellets are obtained by impregnating a porous body of metal such as iron or copper with the surface-treating agent of the present disclosure to which a catalyst has been added.

The catalyst may be any suitable acid or base. The acid catalyst may be, for example, acetic acid, formic acid, or trifluoroacetic acid. The base catalyst may be, for example, ammonia or organic amine.

In the above-described manner, a layer derived from the surface-treating agent of the present disclosure is formed on the substrate surface, and the article of the present disclosure is produced. The layer thus obtained has both high surface lubricity and high friction durability. The layer may have not only high friction durability but also have, depending on the formulation of the surface-treating agent used, water-repellency, oil-repellency, antifouling properties (e.g., preventing grime such as fingerprints from adhering), waterproof properties (preventing water from entering electronic components and the like), surface lubricity (or a lubricating property, for example, such as removability by wiping of grime such as fingerprints, and excellent tactile sensations to the fingers), and the like, and may be suitably used as a functional thin film.

That is, the present disclosure further relates to an optical material having a layer derived from the surface-treating agent of the present disclosure as an outermost layer.

The optical material preferably includes a wide variety of optical materials in addition to optical materials relating to displays and the like as exemplified below: for example, displays such as cathode ray tubes (CRTs; e.g., PC monitors), liquid crystal displays, plasma displays, organic EL displays, inorganic thin-film EL dot matrix displays, rear projection displays, vacuum fluorescent displays (VFDs), field emission displays (FEDs); protective plates for such displays; and those obtained by performing an antireflection film treatment on their surfaces.

The article having a layer obtained according to the present disclosure may be, but is not limited to, an optical member. Examples of the optical member include lenses of glasses or the like; front surface protective plates, antireflection plates, polarizing plates, and anti-glare plates for displays such as PDPs and LCDs; touch panel sheets for devices such as mobile phones and personal digital assistants; disc surfaces of optical discs such as Blu-ray (R) discs, DVD discs, CD-Rs, and MOs; optical fibers; and display surfaces of watches and clocks.

The article having a layer obtained according to the present disclosure may be an automobile interior/exterior material. Examples of exterior materials include windows, light covers, and aftermarket camera covers. Examples of interior materials include instrument panel covers, navigation system touch panels, and decorative interior materials.

The article having a layer obtained according to the present disclosure may be medical equipment or a medical material.

The thickness of the layer is not limited. The thickness of the layer in the case of an optical member is in the range of 1 to 50 nm, 1 to 30 nm, and preferably 1 to 15 nm, from the viewpoint of optical performance, surface lubricity, friction durability, and antifouling properties.

The present disclosure provides [1] to below. [1] A fluoropolyether group-containing silane compound of the following formula (A1) or (A2):

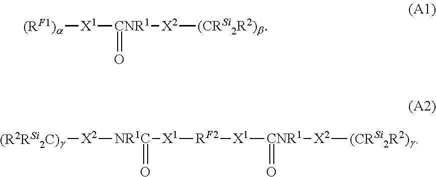

wherein
R^{F1} is represented by Rf¹—R^{F}—O_{q}—;
R^{F2} is represented by —Rf²ₚ—R^{F}—O_{q}—;
R^{f1} is a C₁₋₁₆ alkyl group optionally substituted with one or more fluorine atoms;
R^{f2} is a C₁₋₆ alkylene group optionally substituted with one or more fluorine atoms;
R^{F} is each independently at each occurrence represented by formula:

—(OC₆F₁₂)ₐ—(OC₅F₁₀)_{b}—(OC₄F₈)_{c}—(OC₃R^{Fa}₆)_{d}—(OC₂F₄)ₑ—(OCF₂)_{f}—;
a, b, c, d, e, and f are each independently an integer of 0 to 200, the sum of a, b, c, d, e, and f is 1 or more, and the occurrence order of the respective repeating units enclosed in parentheses provided with a, b, c, d, e, or f is not limited in the formula;
R^{Fa} is each independently at each occurrence a hydrogen atom, a fluorine atom, or a chlorine atom;
p is 0 or 1;
q is independently 0 or 1;
α is an integer of 1 to 9;
β is an integer of 1 to 9; and
γ is each independently an integer of 1 to 9;
X¹ is each independently at each occurrence a single bond or a di- to decavalent organic group;
R¹ is each independently at each occurrence a hydrogen atom, a C₁₋₄ alkyl group, —R², or —R^{Si};
X² is each independently at each occurrence a single bond or a di- to decavalent organic group;
—X¹—C(O)NR¹—X²— is each independently at each occurrence a di- to decavalent organic group;
R² is each independently at each occurrence represented by —CH₂—R⁵¹;
R⁵¹ is each independently a monovalent organic group having an oxyalkylene group;
R^{Si} is each independently at each occurrence represented by the following formula (S1):

—X³—SiR^{b1}ₗ₁R^{c1}₃₋ₗ₁ (S1)

X³ is each independently at each occurrence a single bond, an oxygen atom, or a divalent organic group;
R^{b1} is each independently at each occurrence a hydroxyl group or a hydrolyzable group;
R^{c1} is each independently at each occurrence a hydrogen atom or a monovalent organic group;
l1 is each independently at each occurrence an integer of 0 to 3; and
in each of formulae (A1) and (A2), at least one l1 is 1.
   [2]. The fluoropolyether group-containing silane compound according to [1], wherein
α is 1, and
X¹ is each independently at each occurrence a single bond, or a divalent organic group represented by the following formula:

—(R⁸⁰)ₚ₄—
wherein
R⁸⁰ is each independently at each occurrence a C₁₋₄ alkylene group optionally substituted with one or more fluorine atoms, or a phenylene group, and;
p4 is 1 or 2.
   [3]. The fluoropolyether group-containing silane compound according to [1] or [2], wherein a is 1, and X¹ is a single bond.
   [4]. The fluoropolyether group-containing silane compound according to any one of [1] to [3], wherein
each of β and γ is 1, and
X² is each independently at each occurrence a single bond, or a divalent organic group represented by the following formula:

—(R^{80′})^{p4′}—,
wherein
R^{80′} is each independently at each occurrence a C₁₋₄ alkylene group optionally substituted with one or more fluorine atoms, or a phenylene group, and
p4′ is 1 or 2.
   [5]. The fluoropolyether group-containing silane compound according to any one of [1] to [4], wherein
β and γ are 1, and
X² is each independently a C₁₋₄ alkylene group.
   [6]. The fluoropolyether group-containing silane compound according to any one of [1] to [5], wherein
R⁵¹ is each independently at each occurrence represented by

—R⁵²—O—(R⁵³—O)ₙ₄—R⁵⁴, or

—R⁵⁵—X⁵⁶;
R⁵² is each independently a single bond or a C₁₋₁₀ alkylene group;
R⁵³ is each independently a C₁₋₄ alkylene group;
n4 is each independently an integer of 0 to 10;
R⁵⁴ is each independently a monovalent hydrocarbon group optionally containing a ring structure;
R⁵⁵ is each independently a single bond or a C₁₋₄ alkylene group; and
R⁵⁶ each independently has a 3- to 20-membered ring structure containing at least one oxygen atom in the ring structure.
   [7]. The fluoropolyether group-containing silane compound according to any one of [1] to [6], wherein
R⁵¹ is each independently at each occurrence represented by —R⁵²—O—(R⁵³—O)ₙ₄—R⁵⁴;
R⁵² is a single bond or a C₁₋₄ alkylene group;
R⁵³ is each independently a C₁₋₄ alkylene group;
n4 is each independently an integer of 1 to 10; and
R⁵⁴ is each independently a monovalent hydrocarbon group optionally containing a ring structure.
   [8]. The fluoropolyether group-containing silane compound according to any one of [1] to [6], wherein
R⁵¹ is each independently at each occurrence represented by —R⁵²—O—R⁵⁴;
R⁵² is a C₁₋₄ alkylene group; and
R⁵⁴ is each independently a monovalent hydrocarbon group optionally containing a ring structure.
   [9]. The fluoropolyether group-containing silane compound according to any one of [6] to [8], wherein R⁵⁴ is each independently a C₁₋₄ alkyl group.
   [10]. The fluoropolyether group-containing silane compound according to any one of [1] to [6], wherein
R⁵¹ is each independently at each occurrence represented by —R⁵⁵—R⁵⁶;
R⁵⁵ is a single bond or a C₁₋₄ alkylene group; and
R⁵⁶ has a 3- to 20-membered ring structure containing at least one oxygen atom in the ring structure.
   [11]. A surface-treating agent comprising the fluoropolyether group-containing silane compound according to any one of [1] to [10].
   [12]. The surface-treating agent according to [11], comprising a compound of formula (A1) and a compound of formula (A2).
   [13]. A surface-treating agent comprising at least one selected from the group consisting of the fluoropolyether group-containing silane compound according to any one of [1] to [10], and a condensation product in which the fluoropolyether group-containing silane compound is at least partially condensed.
   [14]. The surface-treating agent according to any one of [11] to [13], further comprising a fluorine-containing oil.
   [15]. The surface-treating agent according to [14], wherein the fluorine-containing oil is contained in an amount of 30 mass % or less based on the total amount of the fluoropolyether group-containing silane compound and the fluorine-containing oil.
   [16]. The surface-treating agent according to any one of [11] to 15, further comprising one or more other components selected from a silicone oil and a catalyst.
   [17]. The surface-treating agent according to [16], further comprising a solvent.
   [18]. The surface-treating agent according to any one of [11] to 17, which is used as an antifouling coating agent or a water-proof coating agent.
   [19]. A pellet comprising the surface-treating agent according to any one of [11] to [18].
   [20]. An article comprising a substrate and a layer on a surface of the substrate, wherein the layer is formed of the compound according to [1] to [10] or the surface-treating agent according to any one of [11] to [18].
   [21]. The article according to [20], which is an optical member.
   [22]. The article according to any one of [20] or [21], which is a display.
   [23]. A compound of the following formula (B1):

NC—X^{2′}—(C(X^{3′}—CH═CH₂)₂R²)_{β} (B1)

wherein
β is an integer of 1 to 9;
R² is each independently at each occurrence represented by —CH₂—R⁵¹;
R⁵¹ is each independently at each occurrence a monovalent organic group having an oxyalkylene group;
X^{2′} is a single bond or a di- to decavalent organic group; and
X^{3′} is each independently a C₁₋₂ alkylene group.
   [24]. The compound according to [23], wherein
β is 1, and
X^{2′} is a divalent organic group represented by the following formula:

—(R^{80″})_{p4″}—
wherein
R^{80″} each independently represents a C₁₋₄ alkylene group optionally substituted with one or more fluorine atoms, or a phenylene group, and
p4″ is 1 or 2.
   [25]. A compound or an acid salt of the compound, wherein the compound is represented by the following formula (B2):

Y¹R¹N—X^{2″}—(C(X^{3′}—CH═CH₂)₂R²)_{β} (B2)

wherein
Y¹ is a hydrogen atom, a tert-butoxycarbonyl group, a benzyloxycarbonyl group, a 9-fluorenylmethyloxycarbonyl group, an allyloxycarbonyl group, a 2,2,2-trichloroethoxycarbonyl group, a 2-(trimethylsilyl)ethoxycarbonyl group, an acetyl group, a trifluoroacetyl group, a methanesulfonyl group, a benzenesulfonyl group, a p-toluenesulfonyl group, a 2-nitrobenzenesulfonyl group, a trifluoromethanesulfonyl group, or a (2-trimethylsilyl)ethanesulfonyl group;
R¹ is a hydrogen atom, a C₁₋₄ alkyl group, —R², or —R^{Si};
at least one of Y¹ and R¹ is a hydrogen atom;
R² is each independently at each occurrence represented by —CH₂—R⁵¹;
R⁵¹ is each independently a monovalent organic group having an oxyalkylene group; and
R^{Si} is each independently at each occurrence represented by the following formula (S1):

—X³—SiR^{b1}ₗ₁R^{c1}₃₋ₗ₁ (S1)
X³ is each independently at each occurrence a single bond, an oxygen atom, or a divalent organic group;
R^{b1} is each independently at each occurrence a hydroxyl group or a hydrolyzable group;
R^{c1} is each independently at each occurrence a hydrogen atom or a monovalent organic group;
l1 is each independently at each occurrence an integer of 0 to 3;
at least one l1 in formula (B2) is 1;
β is an integer of 1 to 9;
X^{2″} is a single bond or a di- to decavalent organic group; and
X^{3′} is each independently a C₁₋₂ alkylene group.
   [26]. The compound according to [25], wherein
β is 1,
X^{2″} is a divalent organic group represented by the following formula:

—(R^{80″′})_{p4″′}—
wherein
R^{80′″} each independently represents a C₁₋₄ alkylene group optionally substituted with one or more fluorine atoms, or a phenylene group, and
p4′″ is 1 or 2.
   [27]. The compound according to any one of [11] to [26], wherein
R⁵¹ is each independently at each occurrence represented by —R⁵²—O—(R⁵³—O)ₙ₄—R⁵⁴ or —R⁵⁵—R⁵⁶;
R⁵² is each independently a single bond or a C₁₋₄ alkylene group;
R⁵³ is each independently a C₁₋₄ alkylene group;
n4 is each independently an integer of 0 to 10;
R⁵⁴ is each independently a monovalent hydrocarbon group optionally containing a ring structure;
R⁵⁵ is each independently a single bond or a C₁₋₄ alkylene group; and
R⁵⁶ each independently has a 3- to 20-membered ring structure containing at least one oxygen atom in the ring structure.
   [28]. The compound according to [27], wherein
R⁵¹ is each independently at each occurrence represented by —R⁵²—O—(R⁵³—O)ₙ₄—R⁵⁴;
R⁵² is a single bond or a C₁₋₄ alkylene group;
R⁵³ is each independently a C₁₋₄ alkylene group;
n4 is each independently an integer of 0 to 10; and
R⁵⁴ is a monovalent hydrocarbon group optionally containing a ring structure.
   [29]. The compound according to [27], wherein
R⁵¹ is each independently at each occurrence represented by —R⁵²—O—R⁵⁴;
R⁵² is a C₁₋₄ alkylene group; and
R⁵⁴ is a monovalent hydrocarbon group optionally containing a ring structure.
   [30]. The compound according to any one of [11] to [29], wherein R⁵⁴ is each independently a C₁₋₄ alkyl group.
   [31]. The compound according to [27], wherein
R⁵¹ is each independently at each occurrence represented by —R⁵⁵—O—R⁵⁶;
R⁵⁵ is a single bond or a C₁₋₄ alkylene group; and
R⁵⁶ is a 3- to 20-membered ring containing at least one oxygen atom in the ring structure.

Embodiments have been described above, but it will be understood that various modifications can be made to embodiments and details without departing from the spirit and the scope of the claims.

### EXAMPLES

The present disclosure will now be described more specifically by way of the Examples below, but the present disclosure is not limited to the Examples. In the Examples, all chemical formulae shown below indicate average compositional features, and the occurrence order of the repeating units forming perfluoropolyether is arbitrary.

### Example 1

To dimethylformamide (130 mL), ethyl cyanoacetate (11.3 g) and potassium carbonate were added, the mixture was stirred at room temperature, and allyl bromide (25.4 mL) was then added dropwise. The mixture was stirred overnight, ethyl acetate was then added, the mixture was washed with water, and then concentrated under reduced pressure, and thus 18.7 g of a compound 1-1 was obtained.

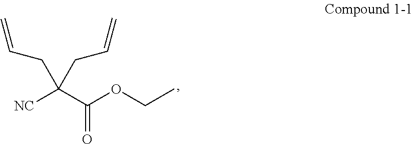

¹H NMR (CDCl₃, 400 MHz) δ[ppm]: 1.30 (t, 3H), 2.54 (dd, 2H), 2.64 (dd, 2H), 4.25 (q, 2H), 5.25-5.22 (m, 4H), 5.86-5.75 (m, 2H).

To dimethyl sulfoxide (150 mL), the compound 1-1 (18.7 g) and 23.4 g of sodium chloride were added, and the mixture was stirred overnight at 180° C. Thereafter, ethyl acetate was added, the mixture was washed with water, and then concentrated under reduced pressure, and thus 8.22 g of a compound 1-2 was obtained.

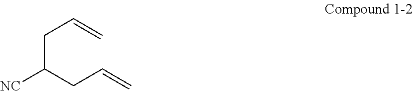

¹H NMR (CDCl₃, 400 MHz) δ [ppm]: 2.36 (tt, 4H), 2.66 (quintet, 1H), 5.17-5.23 (m, 4H), 5.76-5.86 (m, 2H).

To tetrahydrofuran (5 mL), the compound 1-2 (1.0 g) was added, the mixture was stirred at −78° C., a solution of lithium diisopropylamide in tetrahydrofuran/hexane (containing lithium diisopropylamide in an amount of 1.0 mol/L, 9.9 mL) was then added dropwise, and the mixture was stirred for 1 hour. To this, 1-bromo-2-(2-methoxyethoxy)ethane (3.02 g) was added dropwise, the mixture was stirred overnight at room temperature, an aqueous hydrochloric acid solution and ethyl acetate were then added, and the aqueous phase was removed. The organic phase was washed with water, concentrated under reduced pressure, and then purified by silica gel column chromatography, and thus 1.43 g of a compound 1-3 was obtained.

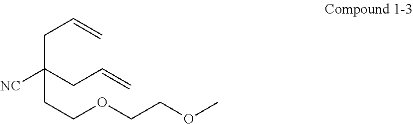 [SMILES: C=CCC(C#N)(CC=C)CCOCCOC]

¹H NMR (CDCl₃, 400 MHz) δ[ppm]: 1.91 (t, 2H), 2.37 (d, 4H), 3.41 (s, 3H), 3.52-3.78 (m, 6H), 5.13-5.29 (m, 4H), 5.75-5.94 (m, 2H).

To tetrahydrofuran (50 mL), lithium aluminum hydride (0.37 g) was added, the mixture was stirred at 0° C., the compound 1-3 (1.43 g) was added dropwise, and the mixture was then stirred overnight at room temperature. An aqueous sodium hydroxide solution was added, and insoluble substances were separated by filtration, followed by concentration under reduced pressure. Thus 1.10 g of a compound 1-4 was obtained.

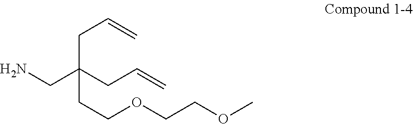 [SMILES: C=CCC(CN)(CC=C)CCOCCOC]

¹H NMR (CDCl₃, 400 MHz) δ[ppm]: 1.20 (brs, 2H), 1.59 (t, 2H), 2.04 (d, 4H), 2.50-2.59 (m, 2H), 3.40 (s, 3H), 3.60-3.65 (m, 6H), 5.01-5.18 (m, 4H), 5.72-5.92 (m, 2H).

To CF₃O(CF₂O)ₘ(CF₂CF₂O)ₙCF₂CO₂CH₃ (m=n=25, 3.0 g), meta-xylene hexafluoride (mXHF, 3.0 g) and the compound 1-4 (0.31 g) were added, and the mixture was stirred overnight at room temperature. Thereafter, perfluorohexane was added, the mixture was washed with acetone, and then concentrated under reduced pressure, and thus 2.63 g of a compound 1-5 was obtained.

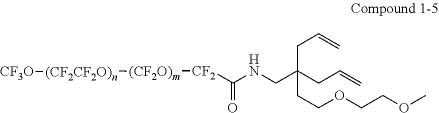

¹H NMR (mXHF, 400 MHz) δ[ppm]: 1.97 (m, 2H), 2.20-2.50 (m, 4H), 3.61-3.72 (m, 5H), 3.80-4.03 (m, 6H), 5.40-5.52 (m, 4H), 6.09-6.43 (m, 2H).

¹⁹F NMR (mXHF, 376 MHz) δ[ppm]: −129.5, −125.8, −90.5, −88.9, −85.4, −85.1, −83.7, −83.4, −80.0, −78.4, −57.7, −56.1, −55.2, −53.5, −51.9.

To the compound 1-5 (1.0 g), mXHF (1.0 g), a solution of Karstedt catalyst in xylene (2%, 19.5 mg) and trimethoxysilane (0.13 g) were added, the mixture was stirred at room temperature for 2 hours, and then concentrated under reduced pressure, and thus a compound 1-6 (0.85 g) was obtained.

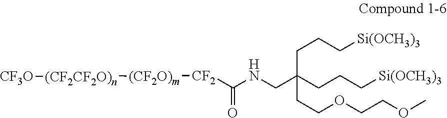

¹H NMR (mXHF, 400 MHz) δ[ppm]: 0.85-1.09 (m, 4H), 1.60-2.05 (m, 10H), 3.57-3.63 (m, 2H), 3.65 (s, 3H), 3.81-4.06 (m, 24H)

¹⁹F NMR (mXHF, 376 MHz) δ[ppm]: −129.5, −125.8, −90.5, −88.9, −85.4, −85.1, −83.7, −83.4, −80.0, −78.4, −57.7, −56.1, −55.2, −53.5, −51.9.

### Example 2

To CF₃O(CF₂O)ₘ(CF₂CF₂O)ₙCF₂COOH (m=36, n=21, 20.9 g), mXHF (20.0 g) and thionyl chloride (1.5 mL) were added, and the mixture was stirred at 90° C. for 3 hours, and then concentrated under reduced pressure. To the obtained solution, mXHF (20.0 g) and the compound 1-4 (2.0 g) were added, and the mixture was stirred overnight at room temperature. To the obtained solution, perfluorohexane was added, the mixture was washed with acetone, and then concentrated under reduced pressure, and thus 18.9 g of a compound 2-1 was obtained.

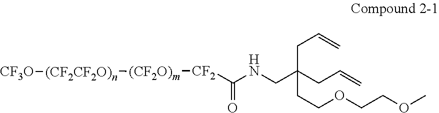

¹H NMR (mXHF, 400 MHz) δ[ppm]: 1.87 (m, 2H), 2.20-2.38 (m, 4H), 3.59-3.62 (m, 5H), 3.80-3.86 (m, 6H), 5.31-5.39 (m, 4H), 6.06-6.16 (m, 2H).

¹⁹F NMR (mXHF, 376 MHz) δ[ppm]: −129.5, −125.8, −90.5, −88.9, −85.3, −85.1, −83.6, −83.4, −80.0, −78.4, −57.7, −56.06, −55.2, −53.5, −51.9.

To the compound 2-1 (16.0 g), mXHF (16.0 g), a solution of Karstedt catalyst in xylene (2%, 0.2 g) and triacetoxymethylsilane and trimechlorosilane (1.7 g) were added, and the mixture was stirred at 60° C. for 3 hours, and then concentrated under reduced pressure. Thereafter, methanol (0.3 g) and trimethyl orthoformate (6.5 g) were added, the mixture was stirred overnight at room temperature, and then concentrated under reduced pressure, and thus a compound 2-2 (14.5 g) was obtained.

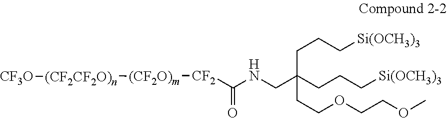

¹H NMR (mXHF, 400 MHz) δ[ppm]: 0.90-0.98 (m, 4H), 1.58-1.92 (m, 10H), 3.56-3.60 (m, 2H), 3.65 (s, 3H), 3.82-2.98 (m, 24H)

¹⁹F NMR (mXHF, 376 MHz) δ[ppm]: −129.5, −125.8, −90.5, −88.9, −85.3, −85.1, −83.6, −83.4, −80.0, −78.4, −57.7, −56.06, −55.2, −53.5, −51.9.

### Example 3

To tetrahydrofuran (24 mL), the compound 1-2 (2.0 g) was added, the mixture was stirred at −78° C., a solution of lithium diisopropylamide in tetrahydrofuran/hexane (containing lithium diisopropylamide in an amount of 1.0 mol/L, 9.9 mL) was then added dropwise, and the mixture was stirred for 1 hour. To this, 1-bromo-2-methoxybutane (5.51 g) was added dropwise, and the mixture was stirred overnight at room temperature. To the obtained solution, an aqueous hydrochloric acid solution and ethyl acetate were added, and the aqueous phase was removed. The organic phase was washed with water, concentrated under reduced pressure, and then purified by silica gel column chromatography, and thus 0.8 g of a compound 3-1 was obtained.

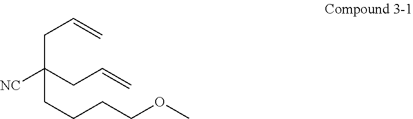

¹H NMR (CDCl₃, 400 MHz) δ[ppm]: 1.56 (m, 6H), 2.32-34 (d, 4H), 3.32 (s, 3H), 3.38 (t, 2H), 5.16-5.24 (m, 4H), 5.77-5.88 (m, 2H).

To tetrahydrofuran (8 mL), lithium aluminum hydride (0.22 g) was added, the mixture was stirred at 0° C., the compound 3-1 (0.8 g) was added dropwise, and the mixture was then stirred overnight at room temperature. To the obtained solution, an aqueous sodium hydroxide solution was added, and insoluble substances were separated by filtration, followed by concentration under reduced pressure. Thus 0.5 g of a compound 3-2 was obtained.

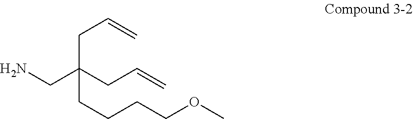

¹H NMR (CDCl₃, 400 MHz) δ[ppm]: 1.20-1.3 (brs, 6H), 1.55 (t, 2H), 2.00 (d, 4H), 2.48 (m, 2H), 3.42 (s, 3H), 3.37 (t, 2H), 5.04-5.07 (m, 4H), 5.74-5.85 (m, 2H).

To CF₃O(CF₂O)ₘ(CF₂CF₂O)ₙCF₂CO₂CH₃ (m=36, n=21, 4.0 g), mXHF (4.0 g) and the compound 3-2 (0.5 g) were added, and the mixture was stirred overnight at room temperature. To the obtained solution, perfluorohexane was added, the mixture was washed with acetone, and then concentrated under reduced pressure, and thus 4.0 g of a compound 3-3 was obtained.

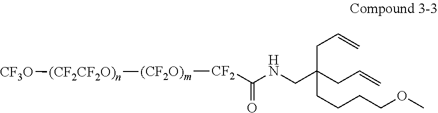

¹H NMR (mXHF, 400 MHz) δ[ppm]: 1.61-1.90 (m, 6H), 2.34 (d, 4H), 3.59-3.62 (m, 5H), 3.72 (t, 2H), 5.40-5.45 (m, 4H), 6.13-6.24 (m, 2H).

¹⁹F NMR (mXHF, 376 MHz) δ[ppm]: −129.5, −125.8, −90.5, −88.9, −85.6, −85.1, −83.7, −83.4, −80.0, −78.3, −57.7, −56.0, −55.2, −53.5, −51.9.

To the compound 3-3 (4.0 g), mXHF (4.0 g), a solution of Karstedt catalyst in xylene (2%, 19.5 mg) and triacetoxymethylsilane and trimechlorosilane (0.5 g) were added, and the mixture was stirred at 60° C. for 3 hours, and then concentrated under reduced pressure. To the obtained solution, mXHF (4.0 g) and methanol (0.1 g) and trimethyl orthoformate (1.7 g) were added, the mixture was stirred overnight at room temperature, and then concentrated under reduced pressure, and thus a compound 3-4 (3.6 g) was obtained.

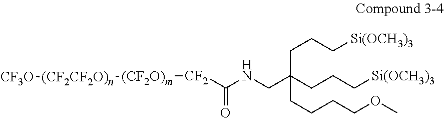

¹H NMR (mXHF, 400 MHz) δ[ppm]: 0.95-0.99 (m, 4H), 1.49-1.85 (m, 14H), 3.56-3.61 (m, 5H), 3.68 (t, 2H), 3.89-4.10 (m, 18H)

¹⁹F NMR (mXHF, 376 MHz) δ[ppm]: −129.5, −125.8, −90.5, −88.9, −85.6, −85.1, −83.7, −83.4, −80.0, −78.3, −57.7, −56.0, −55.2, −53.5, −51.9.

### Example 4

To tetrahydrofuran (100 mL), lithium aluminum hydride (15.4 g) was added, the mixture was stirred at ° C., the compound 1-1 (19.6 g) was added dropwise, and the mixture was then stirred overnight at room temperature. To the obtained solution, water and an aqueous sodium hydroxide solution were added, and insoluble substances were separated by filtration, followed by concentration under reduced pressure. Thus 17.5 g of a compound 4-1 was obtained.

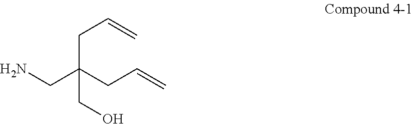

¹H NMR (CDCl3, 400 MHz) δ[ppm]: 2.07-2.09 (m, 4H), 2.76 (s, 2H), 3.56 (s, 2H), 5.02-5.12 (m, 4H), 5.74-5.87 (m, 2H).

To dichloromethane (60 mL), the compound 4-1 (15.3 g) and triethylamine (8.1 g) were added, the mixture was stirred at 0° C., t-butyl dicarbonate (17.4 g) was added dropwise, and the mixture was then stirred overnight at room temperature. To the obtained solution, water was added, the mixture was extracted with dichloromethane, and the solvent was then distilled off, followed by purification through a column. Thus 12.9 g of a compound 4-2 was obtained. In the following, “Boc” means a tert-butoxycarbonyl group.

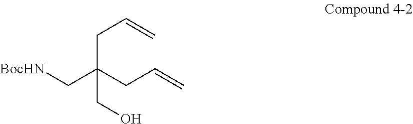 [SMILES: C=CCC(CO)(CC=C)CNC(=O)OC(C)(C)C]

¹H NMR (CDCl₃, 400 MHz) δ[ppm]: 1.44 (s, 9H), 1.89-2.08 (m, 4H), 3.01 (d, 2H), 3.27 (d, 2H), 4.04 (t, 1H), 5.08-5.18 (m, 4H), 5.77-5.87 (m, 2H).

To tetrahydrofuran (10 mL), the compound 4-2 (1.28 g) and sodium hydride (60%, 0.24 g) were added, and the mixture was stirred at 0° C. for 30 minutes. Subsequently, iodomethane (0.71 g) was added dropwise, and the mixture was stirred overnight at room temperature. To the obtained solution, water was added, the mixture was extracted with dichloromethane, and the solvent was then distilled off, followed by purification through a column. Thus 0.55 g of a compound 4-3 was obtained.

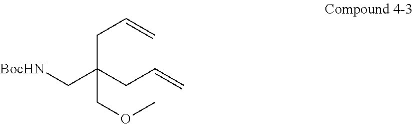 [SMILES: C=CCC(CC=C)(CNC(=O)OC(C)(C)C)COC]

¹H NMR (CDCl₃, 400 MHz) δ[ppm]: 1.44 (s, 9H), 2.05 (d, 4H), 3.12 (d, 2H), 3.18 (s, 2H), 3.32 (s, 3H), 5.05-5.09 (m, 4H), 5.75-5.86 (m, 2H).

To ethyl acetate (5 mL), the compound 4-3 (0.27 g) and a solution of hydrogen chloride in ethyl acetate (1.5 mL) were added, and the mixture was stirred overnight at room temperature. To the obtained solution, an aqueous sodium hydrogen carbonate solution was added to a pH of 7, the solution was then extracted with ethyl acetate, the solvent was distilled off. Thus 0.11 g of a compound 4-4 was obtained.

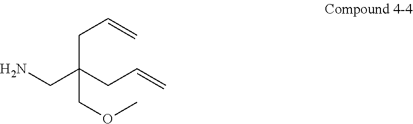

¹H NMR (CDCl₃, 400 MHz) δ[ppm]: 1.42 (brs, 2H), 2.04 (d, 4H), 2.59 (s, 2H), 3.17 (s, 2H), 3.31 (s, 3H), 5.05-5.09 (m, 4H), 5.76-5.86 (m, 2H).

To CF₃O(CF₂O)ₘ(CF₂CF₂O)ₙCF₂CO₂CH₃ (m=36, n=21, 1.3 g), mXHF (1.3 g) and the compound 4-4 (0.05 g) were added, and the mixture was stirred overnight at room temperature. To the obtained solution, perfluorohexane was added, the mixture was washed with acetone and an aqueous hydrochloric acid solution, and then concentrated under reduced pressure, and thus 1.30 g of a compound 4-5 was obtained.

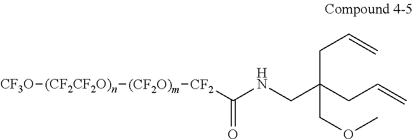

¹H NMR (mXHF, 400 MHz) δ[ppm]: 2.25 (m, 4H), 3.43-3.48 (m, 7H), 5.18-5.23 (m, 4H), 5.88-5.99 (m, 2H).

¹⁹F NMR (mXHF, 376 MHz) δ[ppm]: −129.5, −125.8, −90.5, −88.8, −85.3, −85.1, −83.7, −83.5, −80.2, −78.4, −57.7, −56.0, −55.2, −53.5, −51.9.

To the compound 4-5 (1.30 g), mXHF (1.3 g), a solution of Karstedt catalyst in xylene (2%, 27 μL), aniline (7 μL) and trimethoxysilane (0.15 g) were added, the mixture was stirred overnight at room temperature, and then concentrated under reduced pressure, and thus a compound 4-6 (1.23 g) was obtained.

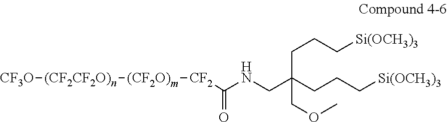

¹H NMR (mXHF, 400 MHz) δ[ppm]: 0.71-0.75 (m, 4H), 1.48-1.59 (m, 8H), 3.37-3.46 (m, 7H), 3.70-3.76 (m, 18H).

¹⁹F NMR (mXHF, 376 MHz) δ[ppm]: −129.5, −125.8, −90.5, −88.8, −85.3, −85.1, −83.7, −83.5, −80.1, −78.2, −57.7, −56.0, −55.2, −53.5, −51.9.

### Synthetic Example 1

To tetrahydrofuran (3.5 g), the compound 1-2 (0.25 g) was added, the mixture was stirred at −78° C., a solution of lithium diisopropylamide in tetrahydrofuran/hexane (containing lithium diisopropylamide in an amount of 1.0 mol/L, 0.25 g) was then added dropwise, and the mixture was stirred for 1 hour. Thereafter, hexaethylene glycol 2-bromoethyl methyl ether (0.98 g) was added dropwise, the mixture was stirred overnight at room temperature, an aqueous hydrochloric acid solution and ethyl acetate were then added, and the aqueous phase was removed. The organic phase was washed with water, concentrated under reduced pressure, and then purified by silica gel column chromatography, and thus 0.28 g of a compound 1A-1 was obtained.

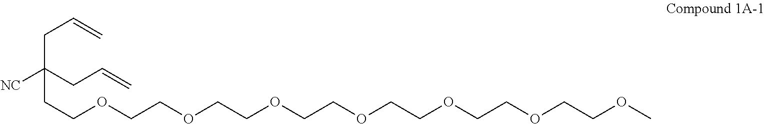 [SMILES: C=CCC(C#N)(CC=C)CCOCCOCCOCCOCCOCCOCCOC]

¹H NMR (CDCl₃, 400 MHz) δ[ppm]: 1.87 (t, 2H), 2.48 (d, 4H), 3.40 (s, 3H), 3.55-3.69 (m, 26H), 5.05-5.40 (m, 4H), 5.79-5.90 (m, 2H).

To tetrahydrofuran (10 mL), lithium aluminum hydride (36 mg) was added, the mixture was stirred at 0° C., the compound 1A-1 (0.28 g) was added dropwise, and the mixture was then stirred overnight at room temperature. Thereafter, an aqueous sodium hydroxide solution was added, and insoluble substances were separated by filtration, followed by concentration under reduced pressure. Thus 0.24 g of a compound 1A-2 was obtained.

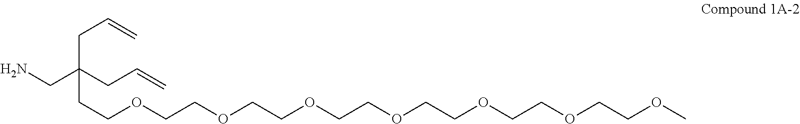 [SMILES: C=CCC(CN)(CC=C)CCOCCOCCOCCOCCOCCOCCOC]

¹H NMR (CDCl₃, 400 MHz) δ[ppm]: 1.43 (s, 2H), 1.56 (t, 2H), 2.00 (d, 4H), 2.50 (s, 2H) 3.37 (s, 3H), 3.52-3.80 (m, 26H), 5.05-5.23 (m, 4H), 5.79-5.90 (m, 2H).

### Synthetic Example 2

To tetrahydrofuran (10 mL), the compound 1-2 (1.21 g) was added, the mixture was stirred at −78° C., a solution of lithium diisopropylamide in tetrahydrofuran/hexane (containing lithium diisopropylamide in an amount of 1.0 mol/L, 10 mL) was then added dropwise, and the mixture was stirred for 1 hour. Thereafter, triethylene glycol 2-bromoethyl methyl ether (2.84 g) was added dropwise, the mixture was stirred overnight at room temperature, an aqueous hydrochloric acid solution and ethyl acetate were then added, and the aqueous phase was removed. The organic phase was washed with water, concentrated under reduced pressure, and then purified by silica gel column chromatography, and thus 2.34 g of a compound 2A-1 was obtained.

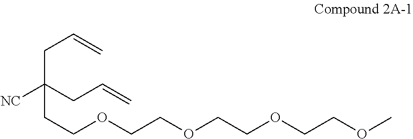 [SMILES: C=CCC(C#N)(CC=C)CCOCCOCCOCCOC]

¹H NMR (CDCl₃, 400 MHz) δ[ppm]: 1.87 (t, 2H), 2.38 (d, 4H), 3.38 (s, 3H), 3.54-3.70 (m, 14H), 5.17-5.25 (m, 4H), 5.79-5.89 (m, 2H).

To tetrahydrofuran (10 mL), lithium aluminum hydride (0.57 g) was added, the mixture was stirred at 0° C., the compound 2A-1 (2.34 g) was added dropwise, and the mixture was then stirred overnight at room temperature. Thereafter, water and an aqueous sodium hydroxide solution was added, and insoluble substances were separated by filtration, followed by concentration under reduced pressure. Thus 2.0 g of a compound 2A-2 was obtained.

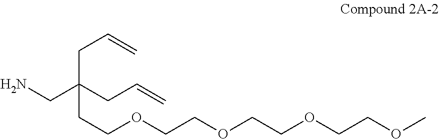 [SMILES: C=CCC(CN)(CC=C)CCOCCOCCOCCOC]

¹H NMR (CDCl₃, 400 MHz) δ[ppm]: 1.28 (t, 2H), 1.75 (d, 4H), 2.25 (s, 2H), 2.31 (brs, 2H), 3.06 (s, 3H), 3.22-3.34 (m, 14H), 4.72-4.79 (m, 4H), 5.45-5.55 (m, 2H).

To CF₃O(CF₂O)ₘ(CF₂CF₂O)ₙCF₂CO₂CH₃ (m=n=25, 2.7 g), mXHF (2.7 g) and the compound 2A-2 (0.28 g) were added, and the mixture was stirred at room temperature for 2 hours. Thereafter, perfluorohexane was added, the mixture was washed with acetone and an aqueous hydrochloric acid solution, and then concentrated under reduced pressure, and thus 2.72 g of a compound 2A-3 was obtained.

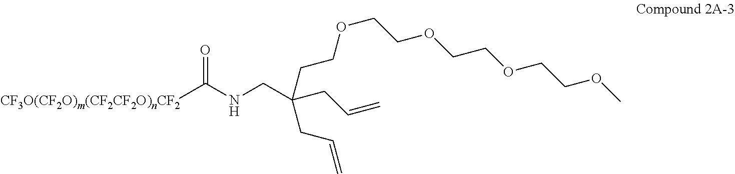

¹H NMR (mXHF, 400 MHz) δ[ppm]: 1.55 (t, 2H), 1.90-2.08 (m, 4H), 3.27 (s, 3H), 3.33 (d, 2H), 3.45-3.48 (m, 2H), 3.53-3.60 (m, 12H), 5.00-5.04 (m, 4H), 5.76-5.87 (m, 2H).

¹⁹F NMR (mXHF, 376 MHz) δ[ppm]: −129.5, −125.8, −90.5, −88.9, −85.3, −85.1, −83.7, −83.5, −79.9, −78.2, −57.7, −56.1, −55.2, −53.5, −51.9.

### Synthetic Example 3

To tetrahydrofuran (10 mL), the compound 1-2 (1.21 g) was added, the mixture was stirred at −78° C., a solution of lithium diisopropylamide in tetrahydrofuran/hexane (containing lithium diisopropylamide in an amount of 1.0 mol/L, 10 mL) was then added dropwise, and the mixture was stirred for 1 hour. Thereafter, 2-bromoethyl methyl ether (1.46 g) was added dropwise, the mixture was stirred overnight at room temperature, an aqueous hydrochloric acid solution and ethyl acetate were then added, and the aqueous phase was removed. The organic phase was washed with water, concentrated under reduced pressure, and then purified by silica gel column chromatography, and thus 1.47 g of a compound 3A-1 was obtained.

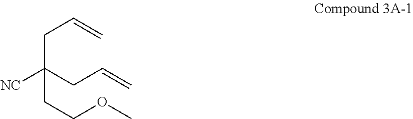

¹H NMR (CDCl₃, 400 MHz) δ[ppm]: 1.85 (t, 2H), 2.38 (d, 4H), 3.35 (s, 3H), 3.59 (t, 2H), 5.17-5.25 (m, 4H), 5.79-5.90 (m, 2H).

To tetrahydrofuran (10 mL), lithium aluminum hydride (0.62 g) was added, the mixture was stirred at 0° C., the compound 3A-1 (1.47 g) was added dropwise, and the mixture was then stirred overnight at room temperature. Water and an aqueous sodium hydroxide solution was added, and insoluble substances were separated by filtration, followed by concentration under reduced pressure. Thus 1.22 g of a compound 3A-2 was obtained.

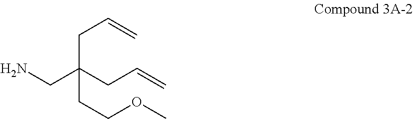

¹H NMR (CDCl₃, 400 MHz) δ[ppm]: 1.14 (brs, 2H), 1.56 (t, 2H), 2.03 (d, 4H), 2.52 (s, 2H), 3.32 (s, 3H), 3.43 (t, 2H), 5.05-5.09 (m, 4H), 5.77-5.86 (m, 2H).

### Synthetic Example 4

To tetrahydrofuran (10 mL), the compound 1-2 (1.21 g) was added, the mixture was stirred at −78° C., a solution of lithium diisopropylamide in tetrahydrofuran/hexane (containing lithium diisopropylamide in an amount of 1.0 mol/dL, 10 mL) was then added dropwise, and the mixture was stirred for 1 hour. Thereafter, diethylene glycol 2-bromoethyl methyl ether (2.38 g) was added dropwise, the mixture was stirred overnight at room temperature, an aqueous hydrochloric acid solution and ethyl acetate were then added, and the aqueous phase was removed. The organic phase was washed with water, concentrated under reduced pressure, and then purified by silica gel column chromatography, and thus 1.95 g of a compound 4A-1 was obtained.

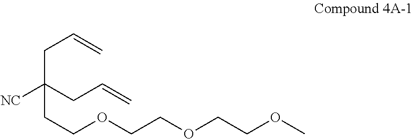 [SMILES: C=CCC(C#N)(CC=C)CCOCCOCCOC]

¹H NMR (CDCl₃, 400 MHz) δ[ppm]: 1.87 (t, 2H), 2.38 (d, 4H), 3.38 (s, 3H), 3.54-3.70 (m, 10H), 5.17-5.25 (m, 4H), 5.79-5.89 (m, 2H).

To tetrahydrofuran (10 mL), lithium aluminum hydride (0.55 g) was added, the mixture was stirred at 0° C., the compound 4A-1 (1.95 g) was added dropwise, and the mixture was then stirred overnight at room temperature. To the obtained solution, water and an aqueous sodium hydroxide solution were added, and insoluble substances were separated by filtration, followed by concentration under reduced pressure. Thus 1.64 g of a compound 4A-2 was obtained.

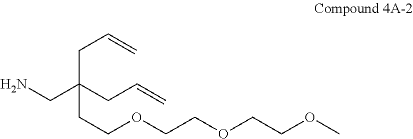 [SMILES: C=CCC(CN)(CC=C)CCOCCOCCOC]

¹H NMR (CDCl₃, 400 MHz) δ[ppm]: 1.34 (t, 2H), 1.80 (d, 4H), 1.97 (brs, 2H), 2.30 (s, 2H), 3.13 (s, 3H), 3.28-3.41 (m, 10H), 4.79-4.85 (m, 4H), 5.52-5.62 (m, 2H).

### Synthetic Example 5

To CF₃O(CF₂O)ₘ(CF₂CF₂O)ₙCF₂CO₂CH₃ (m=36, n=21, 4.0 g), mXHF (4.0 g) and the compound 4-1 (0.17 g) were added, and the mixture was stirred overnight at room temperature. To the obtained solution, perfluorohexane was added, the mixture was washed with acetone and an aqueous hydrochloric acid solution, and then concentrated under reduced pressure, and thus 4.06 g of a compound 5A-1 was obtained.

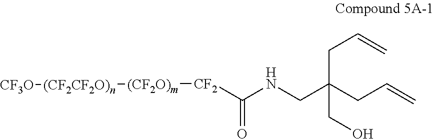

¹H NMR (mXHF, 400 MHz) δ[ppm]: 1.82-1.98 (m, 4H), 3.18 (d, 2H), 3.32-3.33 (m, 2H), 3.42 (brs, 1H), 4.95 (d, 4H), (m, 2H).

¹⁹F NMR (mXHF, 376 MHz) δ[ppm]: −129.5, −125.8, −90.5, −88.8, −85.3, −85.1, −83.7, −83.5, −80.0, −78.3, −57.7, −56.0, −55.2, −53.5, −51.9.

To the compound 5A-1 (1.9 g), ASAHIKLIN AK 225 (3.5 mL) manufactured by AGC Inc., diisopropylethylamine (0.22 g) and N,N-dimethylaminopyridine (0.01 g) were added. The solution was cooled to 0° C., chloromethyl ether (0.08 g) was then added, and the mixture was stirred overnight at 40° C. To the obtained solution, perfluorohexane was added, the mixture was washed with water, and then concentrated under reduced pressure, and thus 1.90 g of a compound 5A-2 was obtained.

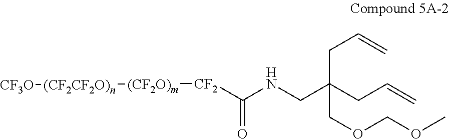

¹H NMR (mXHF, 400 MHz) δ[ppm]: 1.93-1.94 (m, 4H), 3.23-3.24 (m, 5H), 3.33 (s, 2H), 4.47 (s, 2H), 4.90-4.94 (m, 4H), 5.57-5.68 (m, 2H).

¹⁹F NMR (mXHF, 376 MHz) δ[ppm]: −129.5, −125.8, −90.5, −88.8, −85.3, −85.1, −83.7, −83.5, −80.2, −78.4, −57.7, −56.0, −55.2, −53.5, −51.9.

### Comparative Example 1

A compound 5-1 (n:m=53:47, n+m=43) was obtained in accordance with the method described in Example 1 of WO 2017/212850.

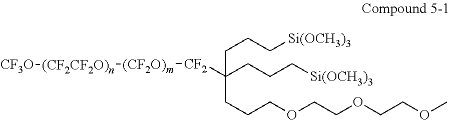

### <Formation of Surface-Treating Layer>

The fluoropolyether group-containing silane compound obtained in each of Examples 1 to 4 and Comparative Example 1 was diluted to a concentration of 0.06 mass % with Novec 7200 (manufactured by 3M Company, ethyl perfluorobutyl ether) to prepare a surface-treating agent. Thereafter, using a spray coating apparatus, the surface-treating agent prepared as described above was applied onto chemically tempered glass (Gorilla 3 manufactured by Corning Incorporated) whose surface had been treated with atmospheric-pressure plasma. The amount of coating was 60 g/m² in terms of surface-treating agent. Subsequently, the substrate coated with the surface-treating agent was heated at 140° C. under atmospheric pressure for 30 minutes.

### <Method for Measuring Static Water Contact Angle>

The static contact angle was measured using a fully automatic contact angle meter Drop Master 700 (manufactured by Kyowa Interface Science Co., Ltd.). Specifically, a substrate having a surface-treating layer to be measured was horizontally placed still, 2 μL of water was dripped from a microsyringe onto a surface of the substrate, and a still image was taken with a video microscope 1 second after the dripping to measure the static contact angle. The static water contact angle was measured at five different points on the surface-treating layer of the substrate, and the average value thereof was calculated and used.

### <Evaluation of Pencil-Eraser Durability>

(Initial Evaluation)

After the surface-treating layer was formed, an excess on the surface was wiped off, and the static water contact angle was measured as an initial evaluation (the number of times eraser was rubbed: 0).

(Evaluation after Pencil-Eraser Durability Test)

Using a rubbing tester (manufactured by Shinto Scientific Co., Ltd.), the static water contact angle of the formed surface-treating layer was measured every 2,500 reciprocations under the following conditions. The measurement was continued until 5,000 reciprocations. The test environment conditions were 25° C. and a humidity of 40% RH.
Eraser: Raber Eraser (manufactured by Minoan)
Ground contact area: 6 mmφ
Travel distance (one way): 40 mm
Travel speed: 3,600 mm/min
Load: 1 kg/6 mmφ

Table 1 shows the results, and Table 2 shows the ratios of the contact angle measured value to the contact angle at a number of times of rubbing of 0 (initial contact angle).

TABLE 1

| | Number of times of rubbing | | |
|---|---|---|---|
| | 0 | 2,500 | 5,000 |
| | times | times | times |
| Example 1 | 113.3 | 109.1 | 106.2 |
| Example 2 | 110.2 | 110.9 | 110.8 |
| Example 3 | 113.0 | 108.6 | 103.2 |
| Example 4 | 113.1 | 105.6 | 105.7 |
| Comparative | 113.6 | 104.6 | 103.0 |
| Example 1 | | | |

TABLE 2

| | Ratio of contact angle to initial contact angle (%) | | |
|---|---|---|---|
| | 0 | 2,500 | 5,000 |
| | times | times | times |
| Example 1 | 100 | 96.3 | 93.7 |
| Example 2 | 100 | 100.6 | 100.5 |
| Example 3 | 100 | 96.1 | 91.3 |
| Example 4 | 100 | 93.4 | 93.5 |
| Comparative | 100 | 92.1 | 90.7 |
| Example 1 | | | |

### INDUSTRIAL APPLICABILITY

The fluoropolyether group-containing silane compound of the present disclosure can be suitably used to form a surface-treating layer on the surfaces of a wide variety of substrates or, in particular, optical members that require friction durability.

What is claimed is:

1. A fluoropolyether group-containing silane compound of the following formula (A1) or (A2): 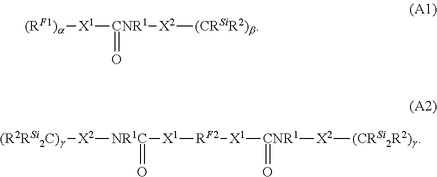
wherein
R^{F1} is represented by Rf¹—R^{F}—O_{q}—;
R^{F2} is represented by —Rf²ₚ—R^{F}—O_{q}—;
R^{f1} is a C₁₋₁₆ alkyl group optionally substituted with one or more fluorine atoms;
R^{f2} is a C₁₋₆ alkylene group optionally substituted with one or more fluorine atoms;
R^{F} is each independently at each occurrence represented by formula:
—(OC₆F₁₂)ₐ—(OC₅F₁₀)_{b}—(OC₄F₈)_{c}—(OC₃R^{Fa}₆)_{d}—(OC₂F₄)ₑ—(OCF₂)_{f}—;
a, b, c, d, e, and f are each independently an integer of 0 to 200, the sum of a, b, c, d, e, and f is 5 or more, and the occurrence order of the respective repeating units enclosed in parentheses provided with a, b, c, d, e, or f is not limited in the formula;
R^{Fa} is each independently at each occurrence a hydrogen atom, a fluorine atom, or a chlorine atom;
p is 0 or 1;
q is independently 0 or 1;
α is an integer of 1 to 9;
β is an integer of 1 to 9; and
γ is each independently an integer of 1 to 9;
X¹ is each independently at each occurrence a single bond or a di- to decavalent organic group;
R¹ is each independently at each occurrence a hydrogen atom, a C₁₋₄ alkyl group, —R², or —R^{Si};
X² is each independently at each occurrence a single bond or a di- to decavalent organic group;
—X¹—C(O)NR¹—X²— is each independently at each occurrence a di- to decavalent organic group;
R² is each independently at each occurrence represented by —CH₂—R⁵¹;
R⁵¹ is each independently a monovalent organic group having an oxyalkylene group;
R^{Si} is each independently at each occurrence represented by the following formula (S1):
—X³—SiR^{b1}ₗ₁R^{c1}₃₋ₗ₁ (S1)
X³ is each independently at each occurrence a single bond, an oxygen atom, or a divalent organic group;
R^{b1} is each independently at each occurrence a hydroxyl group or a hydrolyzable group;
R^{c1} is each independently at each occurrence a hydrogen atom or a monovalent organic group;
l1 is each independently at each occurrence an integer of 0 to 3; and
in each of formulae (A1) and (A2), at least one l1 is 1.

2. The fluoropolyether group-containing silane compound according to claim 1, wherein
α is 1, and
X¹ is each independently at each occurrence a single bond, or a divalent organic group represented by the following formula:
—(R⁸⁰)ₚ₄—
wherein
R⁸⁰ is each independently at each occurrence a C₁₋₄ alkylene group optionally substituted with one or more fluorine atoms, or a phenylene group, and;
p4 is 1 or 2.

3. The fluoropolyether group-containing silane compound according to claim 1, wherein
each of β and γ is 1, and
X² is each independently at each occurrence a single bond, or a divalent organic group represented by the following formula:
—(R^{80′})_{p4′}—
wherein
R^{80′} is each independently at each occurrence a C₁₋₄ alkylene group optionally substituted with one or more fluorine atoms, or a phenylene group, and
p4′ is 1 or 2.

4. The fluoropolyether group-containing silane compound according to claim 1, wherein
R⁵¹ is each independently at each occurrence represented by
—R⁵²—O—(R⁵³—O)ₙ₄—R⁵⁴, or
—R⁵⁵—X⁵⁶;
R⁵² is each independently a single bond or a C₁₋₁₀ alkylene group;
R⁵³ is each independently a C₁₋₄ alkylene group;
n4 is each independently an integer of 0 to 10;
R⁵⁴ is each independently a monovalent hydrocarbon group optionally containing a ring structure;
R⁵⁵ is each independently a single bond or a C₁₋₄ alkylene group; and
R⁵⁶ each independently has a 3- to 20-membered ring structure containing at least one oxygen atom in the ring structure.

5. The fluoropolyether group-containing silane compound according to claim 1, wherein
R⁵¹ is each independently at each occurrence represented by —R⁵²—O—(R⁵³—O)ₙ₄—R⁵⁴;
R⁵² is a single bond or a C₁₋₄ alkylene group;
R⁵³ is each independently a C₁₋₄ alkylene group;
n4 is each independently an integer of 1 to 10; and
R⁵⁴ is each independently a monovalent hydrocarbon group optionally containing a ring structure.

6. The fluoropolyether group-containing silane compound according to claim 1, wherein
R⁵¹ is each independently at each occurrence represented by —R⁵²—O—R⁵⁴;
R⁵² is a C₁₋₄ alkylene group; and
R⁵⁴ is each independently a monovalent hydrocarbon group optionally containing a ring structure.

7. The fluoropolyether group-containing silane compound according to claim 4, wherein R⁵⁴ is each independently a C₁₋₄ alkyl group.

8. The fluoropolyether group-containing silane compound according to claim 1, wherein
R⁵¹ is each independently at each occurrence represented by —R⁵⁵—R⁵⁶;
R⁵⁵ is a single bond or a C₁₋₄ alkylene group; and
R⁵⁶ has a 3- to 20-membered ring structure containing at least one oxygen atom in the ring structure.

9. A surface-treating agent comprising the fluoropolyether group-containing silane compound according to claim 1.

10. The surface-treating agent according to claim 9, comprising a compound of formula (A1) and a compound of formula (A2).

11. A surface-treating agent comprising at least one selected from the group consisting of the fluoropolyether group-containing silane compound according to claim 1, and a condensation product in which the fluoropolyether group-containing silane compound is at least partially condensed.

12. The surface-treating agent according to claim 9, further comprising a fluorine-containing oil.

13. The surface-treating agent according to claim 12, wherein the fluorine-containing oil is contained in an amount of 30 mass % or less based on the total amount of the fluoropolyether group-containing silane compound and the fluorine-containing oil.

14. The surface-treating agent according to claim 9, further comprising one or more other components selected from a silicone oil and a catalyst.

15. The surface-treating agent according to claim 14, further comprising a solvent.

16. The surface-treating agent according to claim 9, which is used as an antifouling coating agent or a water-proof coating agent.

17. A pellet comprising the surface-treating agent according to claim 9.

18. An article comprising a substrate and a layer on a surface of the substrate, wherein the layer is formed of the compound according to claim 1.

19. The article according to claim 18, which is an optical member.

20. The article according to claim 18, which is a display.
